(19) United States
(12) Patent Application Publication
(10) Pub. No.: US 2008/0270164 A1
(43) Pub. Date: Oct. 30, 2008

(54) SYSTEM AND METHOD FOR MANAGING A PLURALITY OF ADVERTISING NETWORKS

(76) Inventors: David S. Kidder, Mamaroneck, NY (US); Munish Gandhi, Ashburn, VI (US); Vernon Steward, New York, NY (US); Nelson Kunkel, Eagle, CO (US)

Correspondence Address: LOWRIE, LANDO & ANASTASI, LLP, ONE MAIN STREET, SUITE 1100, CAMBRIDGE, MA, 02142, US

(21) Appl. No.: 11/960,922

(22) Filed: Dec. 20, 2007

Related U.S. Application Data
(60) Provisional application No. 60/876,446.
(60) Provisional application No. 60/892,505, filed on Mar. 1, 2007.
(60) Provisional application No. 60/972,374, filed on Sep. 14, 2007.

(51) Int. Cl. G06Q 10/00

(52) U.S. Cl. 705/1

(57) ABSTRACT

According to one aspect of the present invention a method and apparatus are described for improving advertising conversions on the Internet. An analysis engine is provided that analyzes raw advertising metrics in order to identify improvements. A treemap based visualization engine allows the user to visualize a tree in two dimensional space. In one embodiment, an action engine includes rapid one-box recommendation that allows the user to take an action to improve an advertising campaign. According to another aspect, a system and method for managing a plurality of advertising networks is also provided. A typical embodiment of the management system integrates the analysis engine, visualization engine, and action engine in order to optimize a user/manager's time and effort in organizing, improving, and managing advertising campaigns across a plurality of advertising networks. The presentation and organization (rendered by the visualization engine) of visual displays of advertising information (compiled by analysis engine) effectively reduces the workload in managing the plurality of advertising networks, additionally, recommendations can be based on advertising information (supplied by the action engine). In one example, visual cues in the form of color designations, bring the user's attention to advertising nodes on which actions are estimated to have the significant impact. The definition of what a significant impact is may be established by default or in other embodiments can be configurable by each particular user or manager. Once the user's attention is brought to a particular advertising node, actions and alerts can be recommended to improve an individual advertising campaign, ad group, keyword, ad copy, and/or ad. In one embodiment, by providing an interface to access to other networks with their own advertising campaigns a plurality of networks can be managed.

### RELATED APPLICATIONS

The following commonly owned, co-pending United States Provisional patent applications are related to the present application and are incorporated by reference herein in their entirety: U.S. Provisional Patent Application No. 60/876,446, entitled “METHOD AND APPARATUS FOR IMPROVING ADVERTISING CONVERSIONS USING TIGHTLY INTEGRATED ANALYSIS, VISUALIZATION AND ACTION ENGINES,” by Munish Gandhi, et al., filed on Dec. 21, 2006; U.S. Provisional Patent Application No. 60/892,505 entitled “METHOD AND APPARATUS FOR IMPROVING ADVERTISING CONVERSIONS USING TIGHTLY INTEGRATED ANALYSIS, VISUALIZATION AND ACTION ENGINES,” by Munish Gandhi, et al., filed on Mar. 1, 2007; and U.S. Provisional Application No. 60/972,374, entitled “SYSTEM AND METHOD FOR MANAGING A PLURALITY OF ADVERTISING NETWORKS,” by Munish Gandhi, et al., filed on Sep. 14, 2007.

### FIELD OF THE INVENTION

The invention relates generally to systems and methods for managing advertising networks.

### BACKGROUND OF THE INVENTION

With the advent of the Internet, online advertising has become widely popular and commonly used among various businesses. In addition to being cost effective and far reaching, it allows businesses to get more information to potential users than more traditional forms of advertising such as publications and media campaigns. Generally, online advertising includes search engine, desktop, email advertising as well as various other forms.

Web based advertising systems are typically measured using certain metrics at different stages of the advertisement presentment and fulfillment process. For example, the number of times an advertisement is shown in measures and typically denoted impressions. Impressions have been based on keywords or content that appears on a site. A click on an advertisement is typically measured as a clickthrus. The advertisement copy typically drives the number of clickthrus. When a viewer takes a desired action on the web site of the advertiser that is often referred to as a conversion. Desired actions typically include sign-up, completion of a survey, and a sale. The cost associated with ads are tracked as costs, and sales as sales.

A multitude of techniques have been developed for measuring the success of advertising campaigns online based on various metrics. These practices often involve determinations of how often users tend to perform desired actions in comparison to costs and various other factors involved. However, these systems generally lack an effective and user-friendly approach to analyzing, visualizing and improving online advertising systems. Accordingly, a need exists for a more efficient way to measure and improve such systems. Further, a need exists for an effective user-friendly interface for online advertising systems.

### SUMMARY OF INVENTION

By implementing the method or systems for managing a plurality of advertising networks, various embodiments of the present invention may overcome some of the shortcomings of conventional advertising management systems. According to one embodiment, the ability to manage various advertisement networks down to the minute details that make up each individual advertisement is made significantly easier through improved visualization of advertisement metrics, as well as by automated tracking of the advertising metrics, and by developing automated recommendations based on analysis of the advertising metrics.

According to one embodiment, a visualization engine is provided for rendering advertising metrics in a user-friendly effective manner. The visualization engine displays aggregated information related to particular elements of advertisements in a visual display that highlights information important to managing and improving advertisements. In one example, the visualization is rendered as a two dimensional treemap of the information associated with the advertisements being managed. The visualization of the tree is rendered using a space filling approach that renders the nodes of the tree as rectangles whose area is proportional to some attribute. Basic treemaps have been adapted to function within the context of an advertising management system by adapting treemap structures to vary according to specific attributes of information related to advertisements.

According to one aspect, advertisements and the information associated with them are organized into a hierarchy to facilitate their display. Advertisements can grouped together at a number of levels in order to represent them and the information related to them visually. In one example, ads are organized by the keywords that are used, as well as by the ad copy that appears in the ad. In another example, at a higher level, keyword, ad copy and ads are organized into an ad groups, where multiple ad groups may refer to one ad. In one embodiment, Ad groups are further organized into ad campaigns, and all the ad campaigns hosted or generated at a particular source are grouped into an advertising network. In another embodiment, the various ad networks being managed are organized into a management account. For example, a manager may have ads with Google adwords (an ad network), where the ads are organized into the ad campaign Boston-Local, which has cooking, dinner, fishing, and paintball associated with it (ad groups). In the example, the ad group dinner contains keywords “boston dinner cruise” “boston dinner cruises” among others. The ad group dinner also contains the ads and ad copy associated with the ad group dinner. According to one embodiment, hierarchical organization facilitates the display of the elements associated with any ad as well as any information/metrics associated with those elements.

According to another aspect, the analysis portion of the advertising management system may be configured to automatically perform actions on the various ads being managed without user intervention. In one embodiment, such actions are related to management accounts, ad networks, advertising campaigns, ad groups, and keywords. One should appreciate that actions can occur at any level of the organization related to an ad or ads. The result is a fine tuning of advertisement vehicles without consuming user time. Even where automated processing is not used, the user's time is optimized by streamlining the presentation of the advertising metrics visually. Additionally, the management system can be configured to prompt the user with recommended actions, for example, when the user runs a mouse pointer over a particular metric or visual display of aggregated information, a window may be displayed with a recommended action. In one embodiment, the user selects an option, for example, by pressing a button, to display recommended actions. In another embodiment, the management system displays additional information that will enable the user to make better decisions regarding an advertising campaign. In one example, a user is attempting to improve advertising copy (“ad copy”) to increase clickthrus for a particular advertising campaign. In the example, the management system displays an option to the user to see ad copy of other advertisers that are performing better or that are in a related advertising space. Typically, the system displays an option to the user to see the ad copy from the best five campaigns with similar targets, geography, and keywords, as examples. One should appreciate the displayed recommendations can be configured to base similarity or recommendations on almost any feature associated with an ad. According to one embodiment, the advertisement management system is configured to notify users/managers when particularly sensitive events occur, and/or where an impact level/threshold is exceeded, in addition to the visual displays of information. Such notification may take place by, for example, e-mail, text message, page, or other messaging formats.

According to one embodiment, the system is configured to visually display a return on investment (ROI) threat level. Based on the ROI threat level, visual displays of aggregated information will appear in different colors. Red typically signifies a severe/high/important alert and/or action level, and actions and alerts put into this category will have a greater impact on the advertising campaign or network being monitored or viewed than an action or alert found in another category. Alternatively, other colors may be used to highlight important actions and/or alerts associated with ads. Actions and alerts may be categorized as high, medium, low severity or may be based on critical, severe, moderate designations, as examples. Different designations may be used to signify particular levels, and more than three levels may be used. According to one aspect, the use of visual cues, in this example color, brings the user's attention to actions and/or alerts of particular significance, and aids in effectively providing systems and methods for managing a plurality of advertising campaigns in some embodiments. Other visual cues may be used by the management system to visually render significance, for example, the size of the display, the color of a graph, font, among others. According to alternative embodiments, significance can be determined by multiple factors, as well as on different individual metrics. For example, an estimated impact on cost determines the significance of a particular action/alert. In one embodiment, each category of severity is grouped based on a the impact the action will have on budget. Different percentages (or ranges) are assigned to different categories. Dollar figures (or ranges) may also be used to define categories. In one embodiment, ROAS (Return On Advertising Spend) determines the significance of particular actions or alerts. For example, a ROAS of—100% generates a high severity action/alert. Various criteria for significance may also be combined.

According to another aspect of an embodiment of the present invention, an integrated management interface is provided to track advertisement metrics across a plurality of advertising networks, aggregate the information, and render the aggregated information in an easily understood, and easily acted upon format. According to one embodiment, each of the plurality of advertising networks will be organized into a management account and typically include multiple advertising campaigns, where each ad campaign represents an organization of ads and information associated with ads by any one of location, by product, by categories, among other options. Each advertising campaign will include information relating to at least one particular ad group, for example Boston—Local (this particular ad group represents an organization of ads (and/or information related to those ads) targeting Boston consumers with locally styled advertising). Each campaign may include multiple ad groups and a variety of geographical targets for each. Ad campaigns (campaigns) may be national, international, local, regional, among others. This variety represents one issue in managing and presenting information in order to enable intelligent decisions and enable a user/manager the ability to review the information at any level of desired detail. According to one embodiment, the aggregation, organization, and presentation of information related to managed ads aids in managing the respective ads.

According to one aspect, rendering advertisement information into visual aggregates enables the management system to highlight areas of particular importance to the user/manager of an advertising portfolio. According to another aspect, the visual aggregation cab be configured to provided additional detail on the occurrence of particular events. In one embodiment, for example, a mouseover event triggers the display of additional information. In another embodiment, additional information is displayed in a balloon associated with the visual aggregate. According to one aspect, such visual aggregates can take the form of advertising nodes. In one embodiment, advertising nodes are elements of a treemap. The advertising nodes may reflect keyword(s), ad copy, a particular ad, or some other level of organization of information related to managing ads. In one embodiment, advertising nodes are configured as aggregates of various levels of information, as well as aggregates of multiple ads, keywords, ad groups, campaigns, and ad networks.

In another embodiment, the management system renders an integrated dashboard for visually grouping and prioritizing advertising information related to the entire advertising network as part of the presentation layer. The presentation layer further organizes the presentation of information into tabs, representing, the integrated dashboard, and actions the may be performed on the advertising network being viewed. In one example, the actions include act (for actions that may be taken on the account), manage (for management functions that may be taken—for example “add an ad campaign”), and analyze (for detailed configurable reporting on various campaigns). In another embodiment, the presentation layer renders the advertising networks as selectable tabs on the left side of the screen, so a user may select by tab a particular network, and select various actions to be performed on that advertising network. The user may then switch over to a different advertising network by selecting a different network tab and can perform similar actions related to that network.

According to one aspect of the present invention, a method for managing a plurality of advertising networks is provided. The method comprises acts of aggregating advertising metrics related to at least one of a plurality of advertising networks, analyzing at least one of the plurality of advertising networks using advertising metrics, displaying the at least one of the plurality of advertising networks visually, displaying an indication related to the visual display of the at least one of the plurality of advertising networks that indicates an action exists for the at least one of the plurality of advertising networks, and indicating, visually, a ranking for the recommendation. According to one embodiment of the present invention, the method further comprises an act of indicating on the visual display of the at least one of the plurality of advertising networks the ranking for a recommendation using a visual cue. According to another embodiment of the invention, the visual cue comprises at least one of color, font, background, texture, size, and shape. According to another embodiment of the invention, aggregating advertising metrics related to at least one of the plurality of advertising networks further comprises aggregating advertising metrics related to at least one of advertisement driver, advertisement quality, conversion process, cost, and sales. According to another embodiment of the invention, the advertising metrics are associated with an advertising node.

According to one embodiment of the present invention, the method further comprises acts of visually displaying the advertising node, and displaying advertising metrics in response to an event. According to another embodiment of the invention, displaying advertising metrics occurs in response to at least one of a browser related event, a temporal event, an update event, and a status event. According to another embodiment of the invention, the act of analyzing at least one of the plurality of advertising networks further comprises an act of weighting advertising metrics. According to another embodiment of the invention, the method further comprises an act of generating a recommendation value based on the weighted advertising metrics. According to another embodiment of the invention, the method further comprises an act of generating a recommendation value based on an estimated impact on the at least one of the plurality of advertising networks.

According to one embodiment of the present invention, the method further comprises an act of visually indicating at least one recommendation value by graphically rendering an advertising node. According to another embodiment of the invention, the act of analyzing at least one of the plurality of advertising networks further comprises an act of determining a return on investment value. According to another embodiment of the invention, the method further comprises an act of visually indicating the return on investment value by graphically rendering an advertising node.

According to one aspect of the present invention, a system for managing a plurality of advertising networks is provided. The system comprises an aggregation engine for aggregating information related to at least one of a plurality of advertising networks, a visualization engine for rendering information related to a managed advertisement, and an analysis engine for analyzing advertising metrics, wherein the analysis engine is further adapted to determine recommendations for the at least one of a plurality of advertising networks. According to one embodiment of the present invention, the system further comprises a dashboard for visually displaying the at least one of a plurality of advertising networks and information related to the managed advertisement. According to another embodiment of the invention, the system further comprises an action engine for providing context to the determined recommendations. According to another embodiment of the invention, the recommendations comprise at least one of an action and an alert related to the at least one of a plurality of advertising networks.

According to one embodiment of the present invention, the analysis engine is further adapted to estimate an impact on at least one of the plurality of advertising networks based at least in part on the recommendation. According to another embodiment of the invention, the visualization engine renders the estimated impact on the advertising network. According to another embodiment of the invention, the visualization renders the estimated impact as part of the dashboard. According to another embodiment of the invention, the visualization engine renders information associated with the managed advertisement as visual aggregates of information. According to another embodiment of the invention, the visual aggregates of information comprise a hierarchical organization. According to another embodiment of the invention, the visual aggregates of information comprise advertising nodes. According to another embodiment of the invention, the visualization engine emphasizes information related to the managed ad using visual cues. According to another embodiment of the invention, the visual cues comprise at least one of color, background, texture, size, shape, and font.

According to one aspect of the present a system for improving online advertising conversions is provided. The system comprises an analysis engine that analyzes the raw advertising metrics to identify one or more improvements, a visualization engine that allows the user to visualize a tree in two-dimensional space, and an action engine that allows a user to take an action to improve its advertising campaign. According to one embodiment of the present invention, the analysis engine is further adapted to organize advertising elements into a hierarchical arrangement. According to another embodiment of the invention, the analysis engine is further adapted to associated the raw advertising metrics with the organized advertising elements. According to another embodiment of the invention, the visualization engine is further adapted to display visual information aggregates. According to another embodiment of the invention, the visual information aggregates comprise the hierarchical advertising elements. According to another embodiment of the invention, the analysis engine is further adapted to provide a recommendation.

According to one embodiment of the present invention, the recommendation comprises at least in part one of an action and alert. According to another embodiment of the invention, the action engine is further adapted to generate context for the recommendation. According to another embodiment of the invention, the visualization engine is further adapted to display visual cues related to the recommendation. According to another embodiment of the invention, the visual cues comprise at least one of color, font, background, texture, size, and shape.

According to one aspect of the present invention, a computer implemented method for improving online advertising conversions is provided. The method comprises analyzing the raw advertising metrics to identify improvements to conversion in online advertising, visualizing a tree in two-dimensional space in a treemap based visualization, and providing a rapid one-box recommendation that allows a user to take an action to improve its advertising campaign. According to one embodiment, the method further comprises an act of providing context associated with the action to improve the advertising campaign. According to another embodiment, analyzing the raw advertising metrics further comprises determining if the raw advertising metrics meet a predefined threshold. According to a further embodiment, the method further comprises an act of estimating an impact on the advertising campaign, based on the recommendation. According to one embodiment, the estimated impact is based, at least in part on, at least one of, a return on investment, click thru rate, conversions, conversion rate, impressions, unique visits, quality score of a landing page, a value of goods, visits to a desired product page, and average advertising position.

According to one aspect of the present invention, a computer-readable medium having computer-readable signals stored thereon that define instructions that, as a result of being executed by a computer, instruct the computer to perform a method for improving online advertising conversions is provided. The method comprises analyzing the raw advertising metrics to identify improvements to conversion in online advertising, visualizing a tree in two-dimensional space in a treemap based visualization, and providing a rapid one-box recommendation that allows a user to take an action to improve its advertising campaign. According to one embodiment, the method further comprises an act of providing context associated with the action to improve the advertising campaign. According to another embodiment, analyzing the raw advertising metrics further comprises determining if the raw advertising metrics meet a predefined threshold. According to a further embodiment, the method further comprises an act of estimating an impact on the advertising campaign, based on the recommendation. According to one embodiment, the estimated impact is based, at least in part on, at least one of, a return on investment, click thru rate, conversions, conversion rate, impressions, unique visits, quality score of a landing page, a value of goods, visits to a desired product page, and average advertising position.

According to one aspect of the present invention, a computer implemented advertising system for managing a plurality of advertising networks is provided. The system comprises a presentation engine for rendering a visual interface for a user to access functions associated with at least one of the plurality of advertising networks, an execution engine for providing and executing functions associated with the at least one of the plurality of advertising networks, and a data engine for analyzing metrics associated with the at least one of the plurality of advertising networks. According to yet another embodiment of the present invention, the data engine is further adapted to receive data from a plurality of advertising networks.

According to one embodiment, the data engine is further adapted to determine whether the analyzed metrics meet a predetermined threshold. According to another embodiment, the predetermined threshold is associated with a recorded change over time in the analyzed metrics. According to another embodiment, the analyzed metrics comprise at least one of a return on investment, click thru rate, conversions, conversion rate, impressions, unique visits, quality score of a landing page, a value of goods, visits to a desired product page, and average advertising position. According to yet another embodiment, the execution engine is further adapted to provide a recommendation. According to a further embodiment, the presentation engine is further adapted to display the recommendation, associated context, and an option for accepting the recommendation. According to one embodiment, the associated context comprises the analyzed metrics associated with the at least one of the plurality of advertising networks. According to another embodiment, the data engine is further adapted to generate an estimated impact on the at least one of the plurality of advertising networks for the recommendation.

According to one aspect of the present invention, a computer-readable medium having computer-readable signals stored thereon that define instructions that, as a result of being executed by a computer, instruct the computer to perform a method for standardizing accounting of consumables is provided. The method comprises acts of aggregating advertising metrics related to at least one of a plurality of advertising networks, analyzing at least one of the plurality of advertising networks using advertising metrics, displaying the at least one of the plurality of advertising networks visually, displaying an indication related to the visual display of the at least one of the plurality of advertising networks that indicates an action exists for the at least one of the plurality of advertising networks, and indicating, visually, a ranking for the recommendation. According to one embodiment of the present invention, the method further comprises an act of indicating on the visual display of the at least one of the plurality of advertising networks the ranking for a recommendation using a visual cue. According to another embodiment of the invention, the visual cue comprises at least one of color, font, background, texture, size, and shape. According to another embodiment of the invention, aggregating advertising metrics related to at least one of the plurality of advertising networks further comprises aggregating advertising metrics related to at least one of advertisement driver, advertisement quality, conversion process, cost, and sales. According to another embodiment of the invention, the advertising metrics are associated with an advertising node.

According to one embodiment of the present invention, the method further comprises acts of visually displaying the advertising node, and displaying advertising metrics in response to an event. According to another embodiment of the invention, displaying advertising metrics occurs in response to at least one of a browser related event, a temporal event, an update event, and a status event. According to another embodiment of the invention, the act of analyzing at least one of the plurality of advertising networks further comprises an act of weighting advertising metrics. According to another embodiment of the invention, the method further comprises an act of generating a recommendation value based on the weighted advertising metrics. According to another embodiment of the invention, the method further comprises an act of generating a recommendation value based on an estimated impact on the at least one of the plurality of advertising networks.

According to one embodiment of the present invention, the method further comprises an act of visually indicating at least one recommendation value by graphically rendering an advertising node. According to another embodiment of the invention, the act of analyzing at least one of the plurality of advertising networks further comprises an act of determining a return on investment value. According to another embodiment of the invention, the method further comprises an act of visually indicating the return on investment value by graphically rendering an advertising node.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings,

FIG. 1 illustrates an embodiment of the login interface for a system for managing a plurality of advertising networks;

FIG. 2 illustrates an embodiment of a dashboard for a system for managing a plurality of advertising networks;

FIGS. 3A-B illustrate embodiments of an act display for highlighting elements of an advertisement network with associated actions;

FIGS. 4A-B illustrate embodiments of a manage display for rendering management options;

FIGS. 5A-E illustrate embodiments of an analyze display for visually rendering report information related to advertisements;

FIG. 6 is an illustration of an embodiment of a system for improving advertising conversions in accordance various embodiments;

FIG. 7 shows an embodiment of a resolution window for a Pause Keyword Action, in accordance with various embodiments of the present invention;

FIG. 8 shows an embodiment of a resolution window for an Increase In Average CPC Alert, in accordance with various embodiments of the present invention;

FIG. 9 shows an embodiment of a resolution window for an Edit Ad Copy Action, in accordance with various embodiments of the present invention;

FIG. 10 shows an embodiment of a resolution window for an Increase Max CPC Action, in accordance with various embodiments of the present invention;

FIG. 11 illustrates an embodiment of a flow for managing a plurality of advertising networks;

FIG. 12 illustrates an embodiment of a flow for managing a plurality of advertising networks;

FIG. 13 illustrates an embodiment of a flow for improving advertising conversions;

FIG. 14 is a block diagram of a system for managing a plurality of advertising networks according to one embodiment of the present invention;

FIG. 15 is a block diagram of a system for managing a plurality of advertising networks according to one embodiment of the present invention; and

FIG. 16 is a block diagram of a system for managing a plurality of advertising networks according to one embodiment of the present invention.

The figures are presented by means of illustration and are not meant to be limiting.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations may be discussed, it is understood that this is done for illustrative purposes only. A person skilled in the relevant art will recognize that other components and configurations may be used without departing from the scope and spirit of the invention.

Some implementations and features are discussed in related applications: U.S. Provisional Patent Application No. 60/876,446, entitled “METHOD AND APPARATUS FOR IMPROVING ADVERTISING CONVERSIONS USING TIGHTLY INTEGRATED ANALYSIS, VISUALIZATION AND ACTION ENGINES”; U.S. Provisional Patent Application No. 60/892,505 entitled “METHOD AND APPARATUS FOR IMPROVING ADVERTISING CONVERSIONS USING TIGHTLY INTEGRATED ANALYSIS, VISUALIZATION AND ACTION ENGINES”; and U.S. Provisional Application No. 60/972,374, entitled “SYSTEM AND METHOD FOR MANAGING A PLURALITY OF ADVERTISING NETWORKS,” by Munish Gandhi, et al., filed on Sep. 14, 2007, the disclosures of which are hereby incorporated by reference.

Advertising systems on the web are measured using a few key metrics at different stages of the advertisement presentment and fulfillment process. For example, these metrics include impressions, clickthrus, and conversions. Impressions may be measured by the appearance of keyword(s) or content on a site. The keywords and content are advertisement drivers for such an ad. The number of impressions can be measured directly by the appearance of advertisement drivers. Clickthrus may be related to the quality of an ad, where the quality of the advertising copy or the attractiveness of the ad/image helps increase clickthrus. Conversions can be measured directly, as well as sales, and revenue. There are many derivative metrics (such as click thru rates (clicks divided by impressions), conversion rate (conversions divided by clicks), sales/conversion, etc.), quality metrics (such as average advertising position (ranking where on the display an ad appears), number of unique visits, quality score of the landing page, and other intermediate metrics (such as value of shopping cart, visits to a desired product page, etc.) Each of these metrics provides information associated with advertisements, and each may provide a basis on which to recommend actions (and/or alerts) to take with respect to advertisements. Recommended actions (and/or alerts) may result in reduced costs, and/or increased sales.

Advertisers would like to minimize the costs associated with an advertising campaign and maximize the number and quality (most importantly the monetary sales value) of conversions. The various embodiments discussed describe also encompass a method and an apparatus to minimize costs and maximize conversion quality, however, the method and apparatus to minimize costs and maximize conversion quality may be implemented on singular advertising networks without providing for additional advertising networks.

According to one aspect of the invention, a method and system for managing a plurality of advertising networks may be implemented as an Internet based web site. The method and system for managing a plurality of advertising networks includes a presentation layer for rendering the plurality of advertising networks under a management account, as well as tabs/references/links for actions that may be taken upon the advertising networks, tabs/references/links for various levels of content detail used in conjunction with the advertising networks, tabs/references/links for each advertising network, and tabs/references/links for management functions associated with the Internet based web site itself. In one embodiment, the tabs are organized so that tabs related to actionable items are place across the top of the interface. In another embodiment, the tabs related to content (for example a tab for an advertising network) are arranged together on the left side of the interface. In one example, the organization of tabs occurs by associating tabs that reflect verbs (e.g. “Act” “Manage” “Analyze”) at the top of a web page and tabs that reflect nouns (e.g. “Advertising Network” “Content Type”) appear on the left side of the web page.

The web site may contain additional information and options to assist in the presentation of information related to the advertising networks, for example, a contextual help button may be toggled on or off. The on mode causes information to be displayed relating to the advertising information display.

Conceptually, according to one aspect, the management method and system is configured to present the answer to two questions for any particular user and/or manager of an advertising account in an easily understood and acted upon visual interface: how are the advertisement(s) performing and what actions should I take to make them better? Although one should appreciate that various embodiments may answer some or none of the those questions, or may provide information related to answering those questions.

According to one aspect, in order to improve the capacity of a user to manage the vast amount of information multiple advertisements generate, the visual aspects rendered in the presentation layer may all have significance. In one particular embodiment, multiple visual cues are used to bring the user's attention to information of significance. For example, color is employed to highlight severity/importance of particular information. Various colors designed to draw the users attention may be used—the most important/significant information using colors designed to visually attract the user more than information of lesser important/significance. In other embodiments, the size and shape of particular visual elements are also used to emphasize importance. Alternatively, order of appearance, and/or the placement of information on a display may also be used to emphasize information. Other mechanisms may be used to visually signify the importance of information related to advertising networks, campaigns, ad groups, keywords, ad copy, and ads. Fonts may be varied, the color(s) of graphs, backgrounds, display texture, among others.

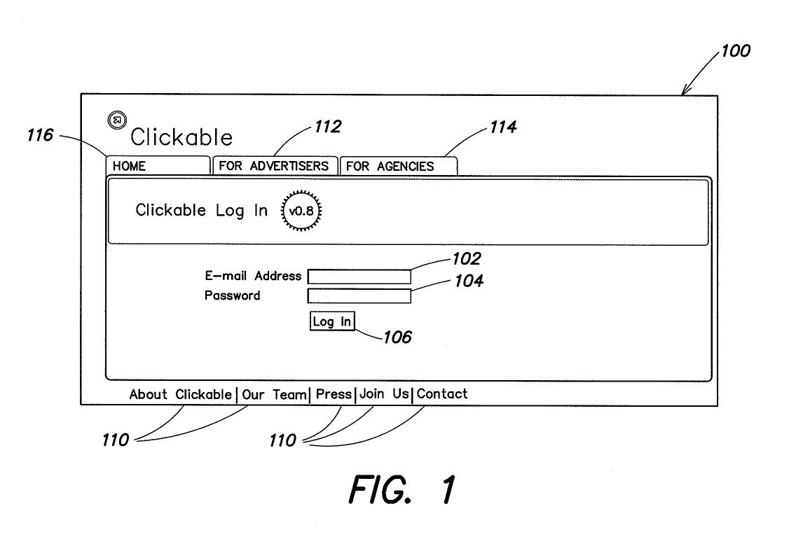

FIGS. 1-5 illustrate embodiments of a management system for managing a plurality of advertising networks. With respect to FIG. 1, shown is a login interface 100 to access a management account for a plurality of advertisement networks. In this example, an e-mail address 102 is used as the user name that identifies a particular user or manager of the management system. It should be appreciated that user names can take any form and are not limited to e-mail addresses as shown in FIG. 1. Upon entry of a valid e-mail address and a valid password in the password field 104, a user obtains access to the management account by clicking on the Log In button 106. One can observe the management system is configurable to define roles for particular users, the tab “For Advertisers” 112 and the tab “For Agencies” 114 are configurable to provide access to a login interface that controls access to a different backend system, as defined by user roles. In one embodiment, a role is defined for advertisers and another role is defined for agencies. Each role can be configured to provide access to different functionality and may direct a particular user to different backend systems or may provide access to a subset of the functions provided for another role. Tab 116 provides access to an optional home page of the management system. In one embodiment, the home page is used to provide information related to the method and system for managing a plurality of advertising networks. Tab 116 can be implemented as a link or reference to a new web page.

The login interface 100 also may include other links to provide additional information related to the method and system for managing a plurality of advertising networks. Links 110 provide access to pages that detail aspects of the method and system for managing a plurality of advertising networks. For example links 110 may provide a vehicle for contacting support relating to the system and method for managing a plurality of advertising networks.

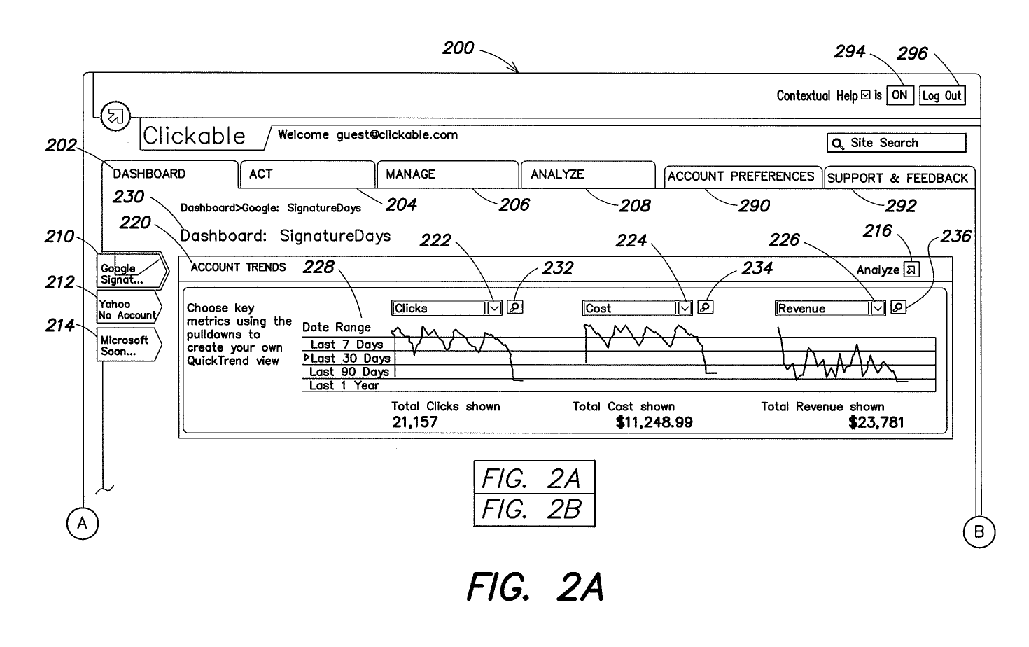

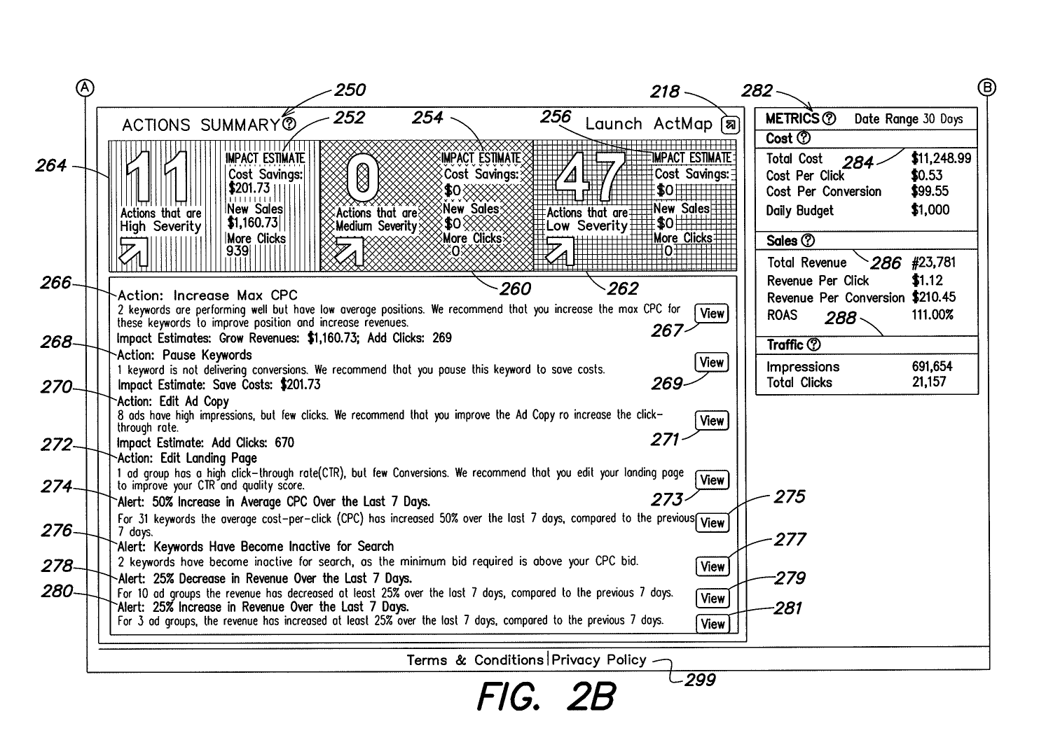

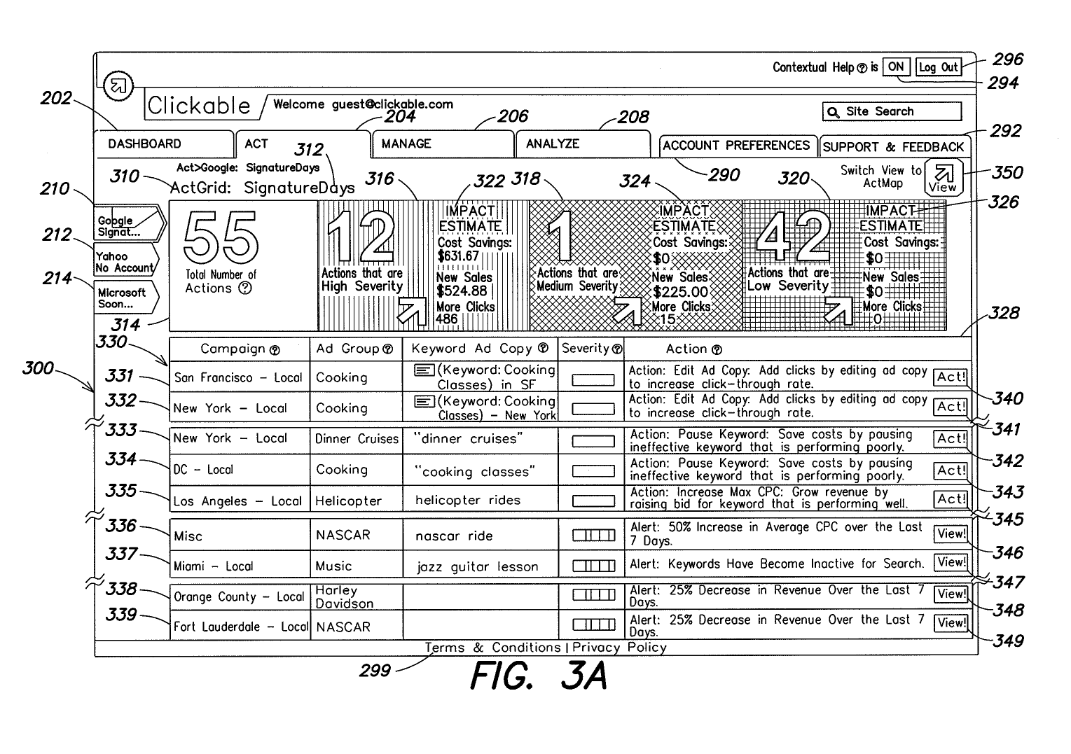

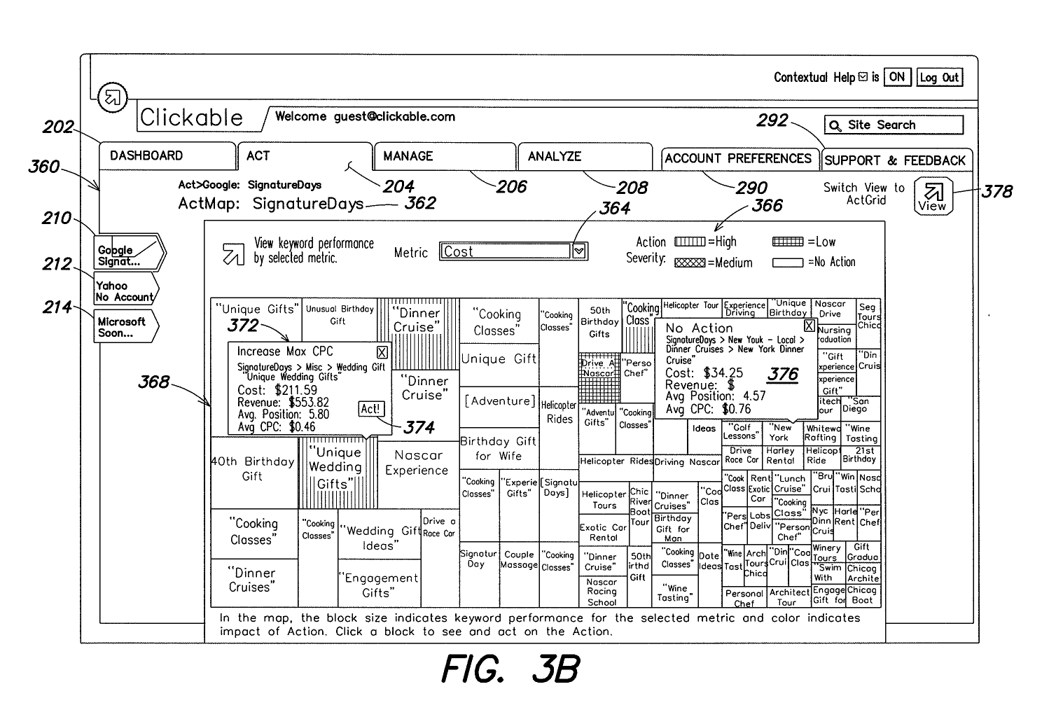

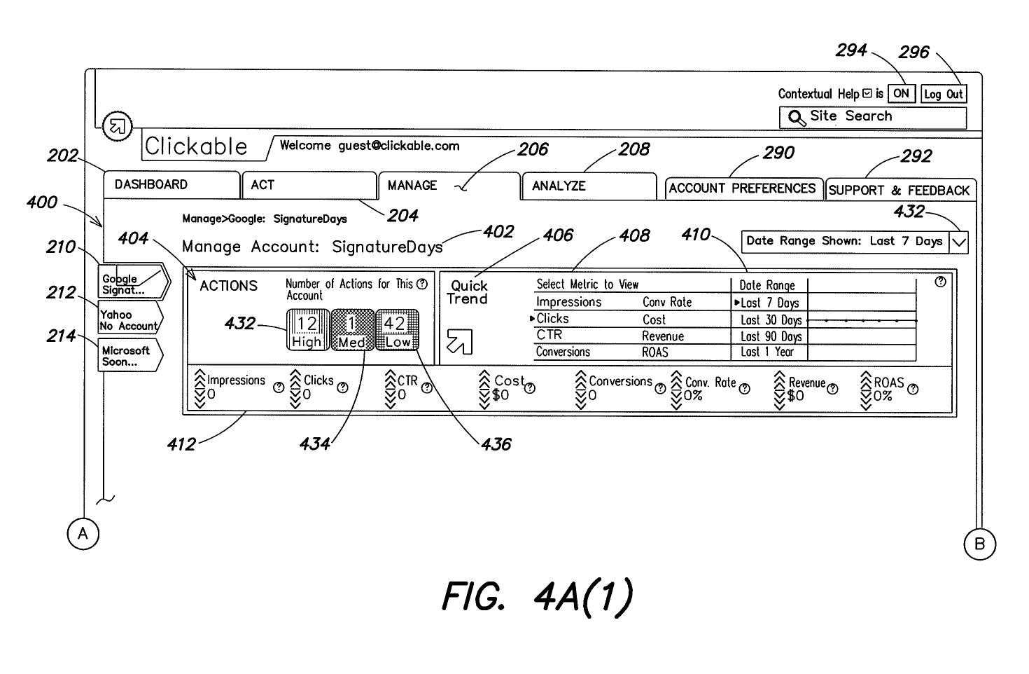

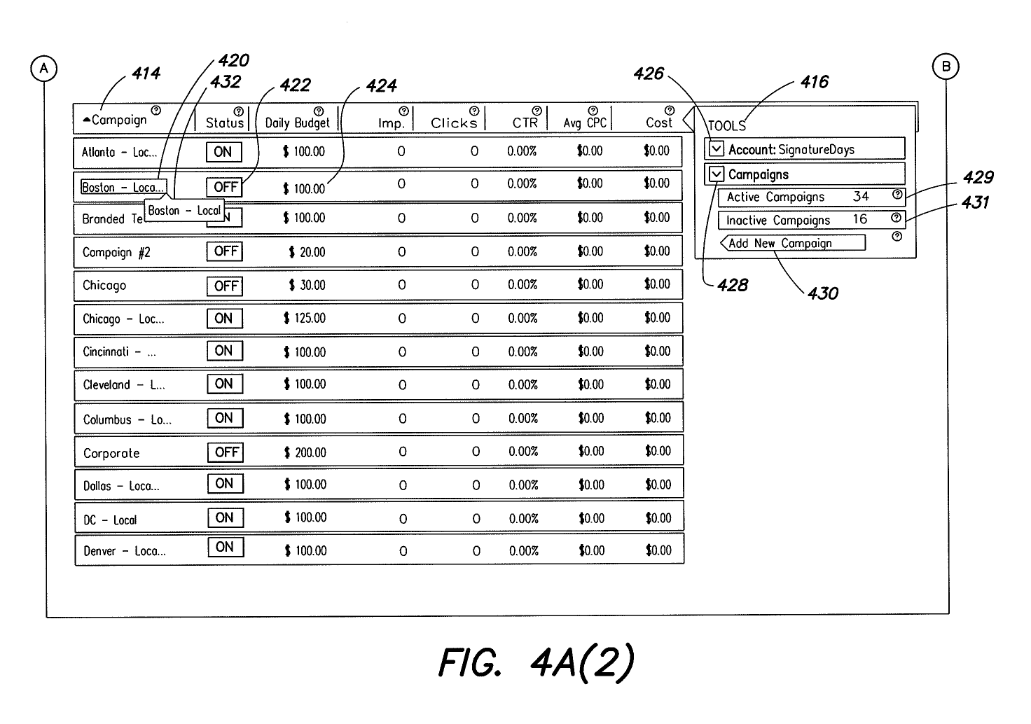

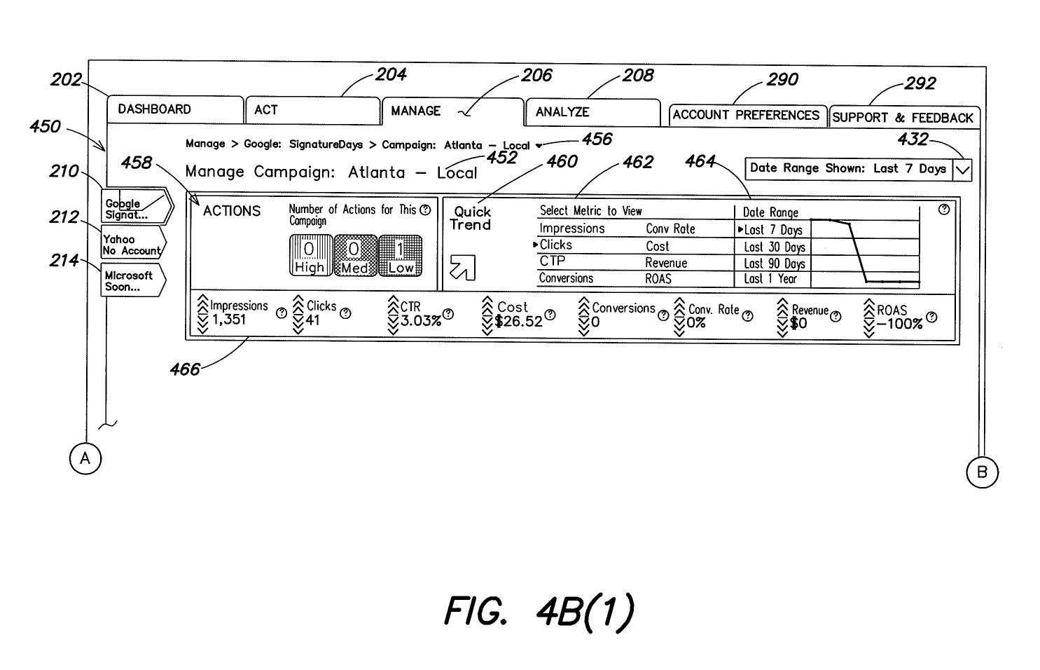

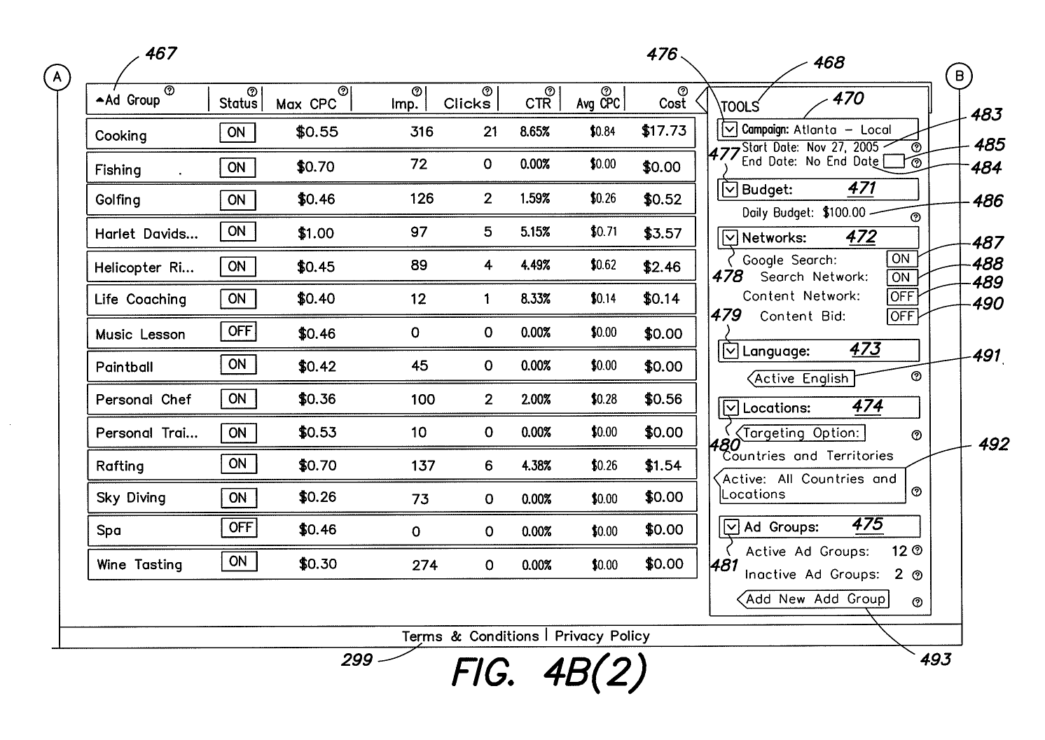

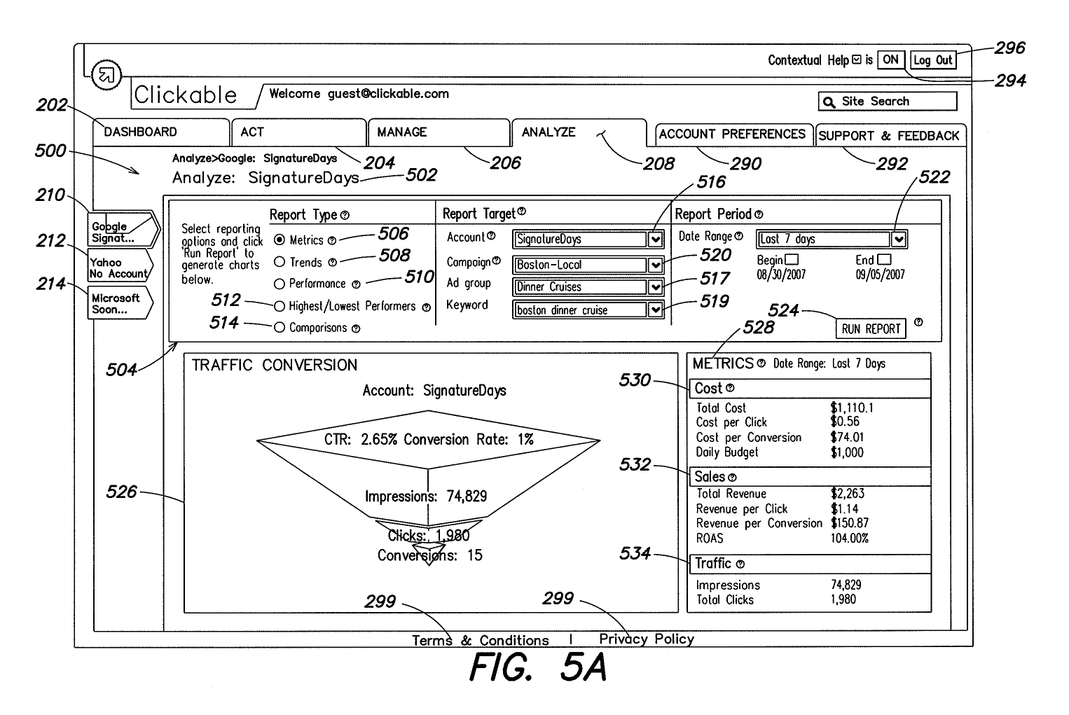

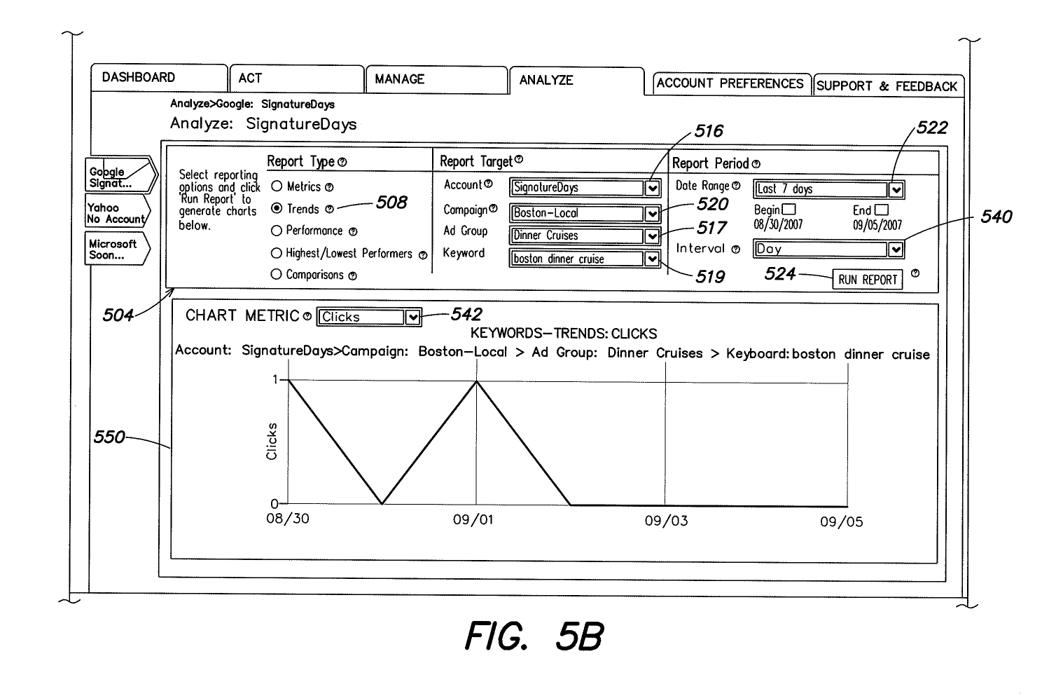

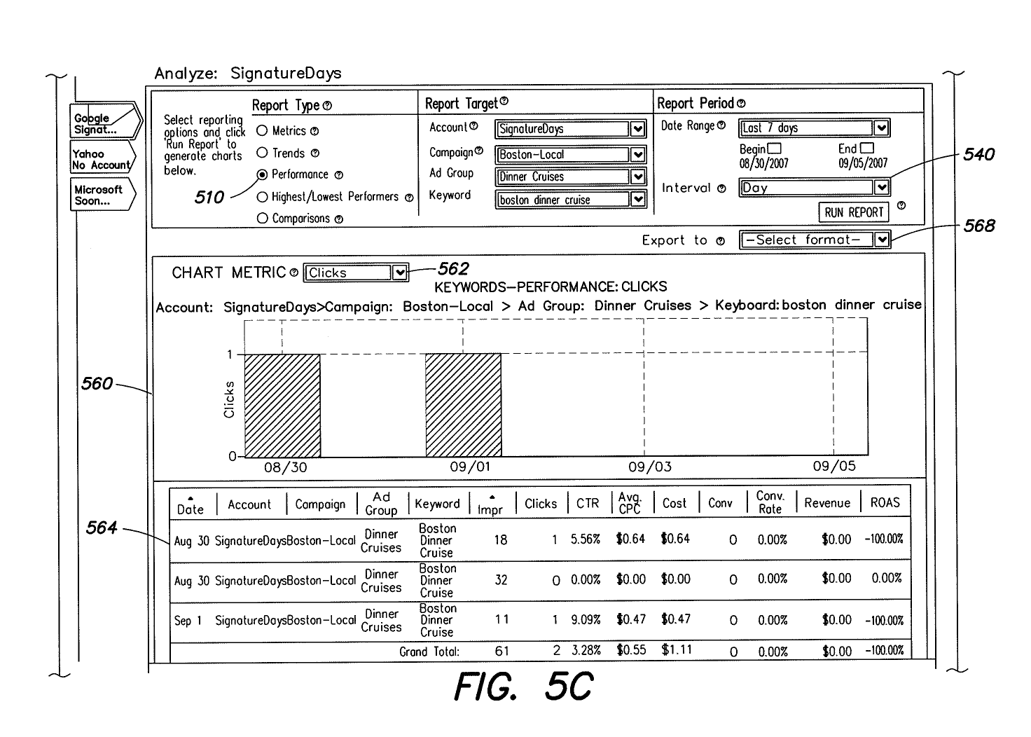

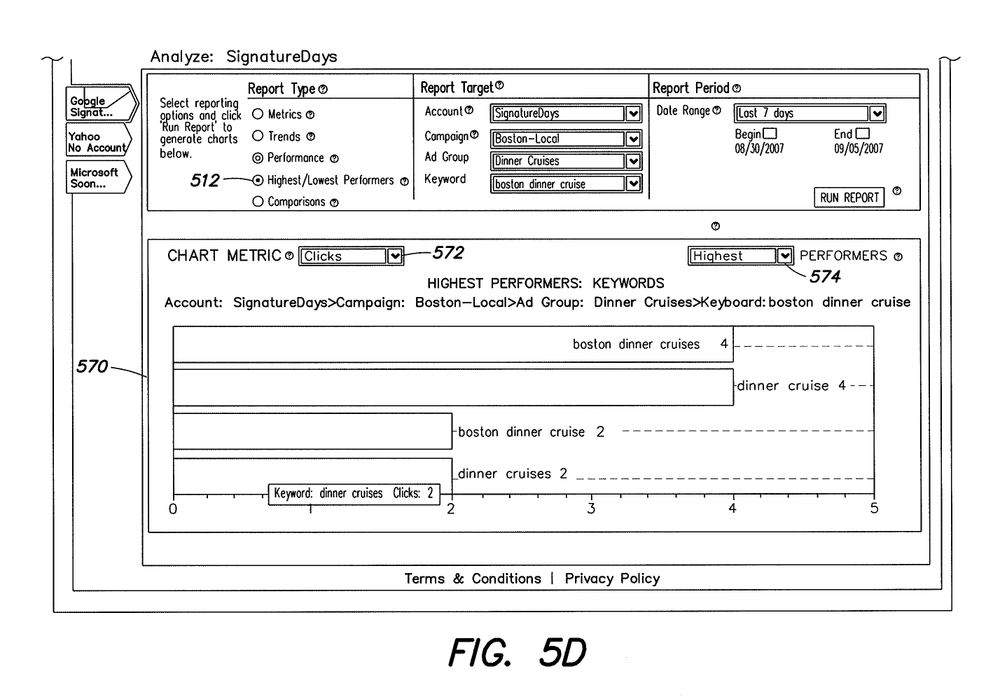

With respect to FIG. 2, shown is an embodiment of a Dashboard Display 200 with the dashboard tab 202 selected. The Dashboard Display 200 is the first interface reached by an authorized user by default. It should be appreciated that the system can be configured to reach other displays as a default page, and the present invention should not be limited to any particular first or default display. Dashboard Display 200 contains tabs for navigating the management site, in particular the “Act” tab 204 directs a user to the “Act” Display 300, discussed in greater detail with respect to FIGS. 3A-B, which provides selections to a user relating to action(s) that are available for particular advertising networks, campaigns, Ad Groups, Keywords, etc. The “Manage” tab 206 directs a user to the Management Display 400, discussed in greater detail with respect to FIGS. 4A-B, that provides reporting and functions to manage advertising campaigns. The “Analyze” tab 208 directs a user to the “Analyze” Display 500, discussed in greater detail with respect to FIGS. 5A-E, that provides analysis and reporting tools that are configurable by the user to report on the advertising metrics tracked for the plurality of advertising networks.

Generally, according to one aspect, the dashboard display for the management system is designed to organize, summarize, and visually display information of importance for a selected advertising network. The dashboard visually represents the over-all well being of the ad network, giving a user the ability to quickly understanding the performance of the managed ad network. Important issues are highlighted, drawing a user's attention using visual cues (color, size, font, border, texture, etc.), and recommended actions may also be presented (alone or in summary format) where they exists. Actions and alerts may be referred to interchangeably as even alerts typically have an action associated with them, for example the user is asked to identify that the alert has been reviewed and/or maintains the alert as active by making selections. According to one aspect, the dashboard display effectively streamlines management of a viewed advertising network, and provides tabs/references/links to quickly do the same for other managed networks in the management account.

As part of the presentation of the Dashboard, the advertising networks to be managed are shown on the left side of the interface, for example, Advertising Network 210 is selected for review, and represents in this example manages an advertising network at the well known Google. In this embodiment, the particular account held at Google has been named “SignatureDays.” The name of the account being managed is shown also at 240, where the dashboard displays the particular advertising account currently being reviewed. The dashboard provides tabs for multiple advertising networks, and as shown in this example, 212 for a network established at the well known Yahoo!, and 214 for a network established at the well known MicroSoft in their “adCenter.” According to one aspect, the management system and method provides a simple interface over which to manage a plurality of advertising networks, simply and effectively. Navigation to and between advertising networks becomes as simple as a mouse click, with visual cues designed to bring a user's attention to items and actions that will have the most significance on each advertising network, account, ad campaign, etc.

In one embodiment, the visual aggregation and representation of the advertising metrics may take the form of graphical representations. For example Account Trends 220 are graphically described over user selectable time periods 238. Shown are three graphs, one for Clicks 232, Cost 234, and Revenue 236 over the last 30 days. The graphs include summary information in the form of the total for each respective metric. Drop down menus 222-226 provide for the user to select any one of the available metrics for graphical display. Such metrics include Impressions (number of times advertisement is viewed online), Clicks (number of times advertisement clicked on), CTR (clickthrough rate—number of clicks advertisement received over number of times shown (impressions)), Cost (money spent on campaigns in an account), Conversions (ad click leads to an event defined by user (e.g. purchase or sale, signup, viewed page, executed demo, among others), Conv. Rate (number of conversions over number of clicks), Revenue (money generated by ad campaigns under account), and ROAS (return on advertising spend—total sale over total cost). It should be appreciated that other metrics can be included in the drop down list and not all of the metrics listed need be shown. Rendering account trends provides the user of the management system quick and readily understood access to the data related to the entire advertising account, which can be quickly compared to other advertising networks by clicking on tabs 210-214. Additionally, the user is provided the opportunity to review any of the metrics in the dropdown lists provided. A user may compare and contrast the various metrics provided. Additionally, incorporated in the graphical displays is a zoom tool 232-236 for enlarging the rendered graph.

The Dashboard Display provides an Actions Summary 250, intelligent actions suggested by the management system and method to improve overall keyword/advertising performance and to improve ROAS. The Action Summary 250 may also include alerts for campaigns, keywords, etc. The actions and their numbers are categories in this example as High, Medium and Low severity. The Action Summary also provides an Impact Estimate 252-256, for estimating the impact of the suggested actions and alert resolution, in terms of cost, new sales, and additional clicks that will be generated should the user elect to accept or follow the management system and method's suggestions. Impact Estimates may also be provided for additional metrics. High severity actions/alerts are highlighted by their background color, in this example, box 260 appears red to bring a user's attention to the significance (i.e. the potential impact on the advertising network) of the High severity actions/alerts. Medium Severity actions/alerts appear in orange, box 262, and the Low Severity actions and alerts appear in yellow, box 264. According to one aspect of the present invention, the management system and method provides visual cues to draw the user's attention to significant metrics, quickly and in an easy to understand format.

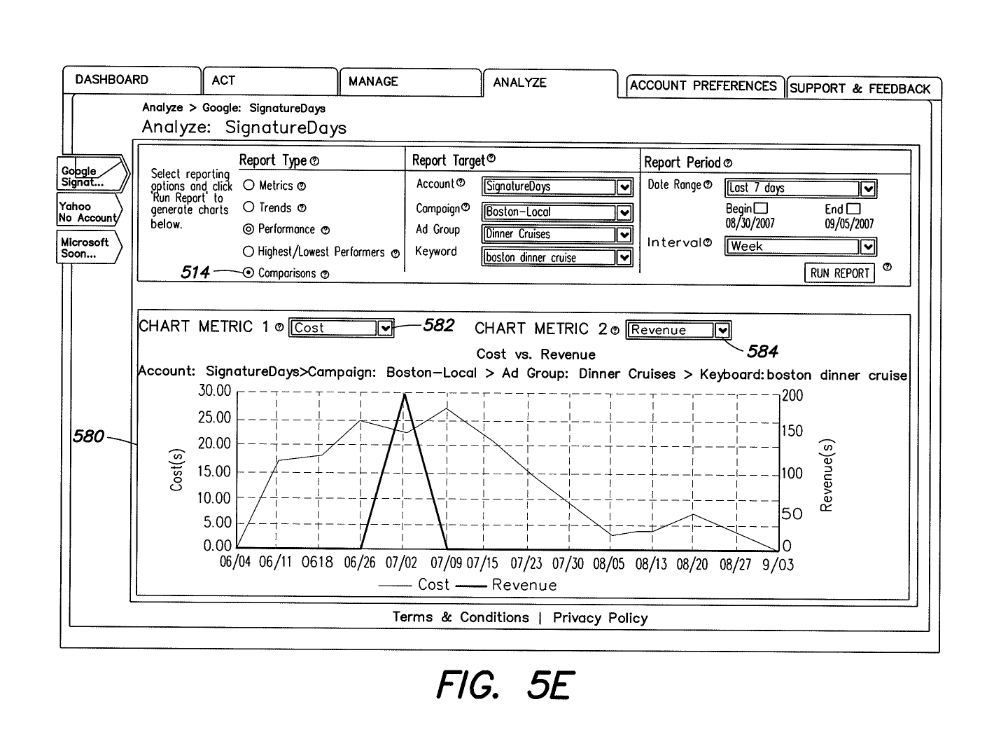

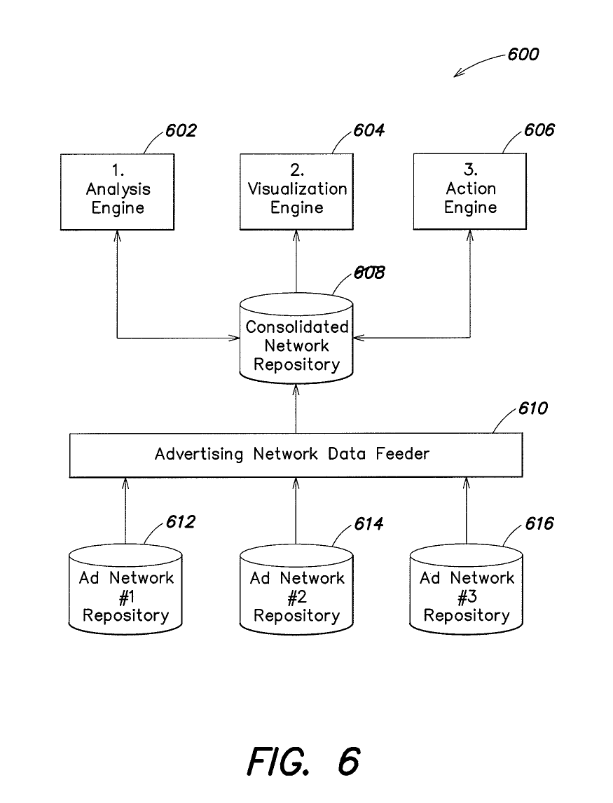

Recommendations For Your Account 270, provides a user with a list of recommended action that can be taken with respect to various campaigns, Ad Groups, Keywords, etc. within the advertising network being reviewed. At 272, multiple actions are suggested that would improve performance of particular campaigns within the advertising network. The recommended action may appears in a standard format, designed facilitate understanding of the recommended action. Some level of detail is provided, as to what aspect of a particular advertisement is generating the recommendation. As can be seen from the first recommended action, the recommendation indicates first the type of activity being identified, in this example Action or Alert. As can be seen form the first recommendation, where an action is recommended, the management system and method will recommend a specific action, for example Increase Max CPC (Maximum Cost Per Click). Based on the analysis of advertising metrics provided for this particular campaign, the management system and method has identified two keywords that are performing well, i.e. generating positive revenue, but on average are being displayed in a low position. In conventional cost per click advertising systems a typical user will submit a maximum bid he or she is willing to pay in order to have their advertisement appear. The amount a particular user is willing to pay may have an impact on where the advertisement is displayed. For example, a lower bid might meet the minimum threshold in order to have the advertisement display, but that particular ad may appear in a lower position than another advertiser who submitted a higher bid. The Analysis Engine 602, discussed in greater detail with respect to FIG. 6, identifies, for example, key words that are performing well, analyzes the relative position of the advertisement containing those keywords, and in conjunction with the Action Engine 606, generates a recommendation that will improve the position of the advertisement (as estimated by the analysis engine 602—increasing the Max CPC will result in increased average position of the advertisement and an estimated increase in revenue). One should note that multiple campaigns may be grouped together in the Recommendations For Your Account 270. Alternatively, each action and/or alert may be shown separately. In one embodiment, the indication that two keywords are performing well, illustrates a circumstance where the two keywords belong to different ad campaigns, and clicking on the View button 267, brings the user to an Act Display that displays only the two actions associated with the Action 266.

In one embodiment, the Dashboard Display 200 also includes a breakdown of the metrics that make up Cost 284, Sales 286, and Traffic 288 figures. The summarized advertising metrics are reported for a predefined range, that may be configurable by the user through an account preferences interface. The account preference interface is accessible via link 290. Metrics Display 282 displays the cost, revenue, and traffic metrics for the advertising network viewed. The breakdown details information that assists the user in making decisions related to the entire advertising network, and enables the user to quickly appreciate the performance over the entire network, saving time and effort in managing the advertising network. Cost 284 details the total cost of the entire network, the cost per click, cost per conversion, and totals the daily budget for the entire network. Sales 286 details indicators of the earnings generated from different campaigns under the network, and presents the user with an interface to monitor revenue metrics quickly and efficiently. Traffic 288 details the numbers of impressions and clicks that different campaigns under an account generate. Again in this embodiment, the user is able to monitor quickly and efficiently advertising metrics across an entire ad network from the dashboard 202.

In one embodiment, additional navigation links are displayed to assist the user, for example Analyze link 216 brings the user the Analyze Display 500, FIG. 5, and the ActMap link 218 brings the user to one display of the Act Display 360, FIG. 3B. Support links are also available to assist the user, Support & Feedback link 292 provides the user with access to support interfaces, and provides the opportunity to submit feedback and contact the maintainer of the system and method for managing a plurality of advertising networks. Additionally according to one embodiment, Contextual Help button 294 may be toggled on an off by the user. In the On Mode, the contextual help will display messages relating to the particular options on the interface associated with question marks. According to another embodiment, when a user drags the mouse pointer over a question mark information relating to the activity, metric, or information will display. Logout button 296 permits a user to end a session. Terms & Conditions and Privacy Policy links 299 provide user access to information related to the use of private information accumulated and/or provided to the Provider of the system and method for managing a plurality of advertising networks.

In one embodiment, a user may access the Act Display in number of ways from the Dashboard 202. A user may click on the Act tab 204, or the Launch ActMap button 208, or a user may click on the view button 267 associated with a particular action 266 or alert 274 and its view button 275. According to this embodiment, how the user accesses the Act Display will effect how the interface is displayed. Typically a user will reach Act Display 300, FIG. 3A, by selecting the Act Tab 204 while viewing the Dashboard Display 200. One should appreciate that certain elements of the interface are available on all displays that are accessed, i.e. the Dashboard, the Act, the Analyze, and the Manage Displays. According to one aspect, the common elements of the interface establish a common look and feel for the interface. The common look and feel makes it easier for a user to navigate and become comfortable with the interface for the management system. In this example, the tabs 202-214 and 290-292 appear on the Dashboard Display 200, Act Display 300, Manage Display 400, and Analyze Display 500. The contextual help button 294, logout button 296, and Terms and Conditions and Privacy Policy Links 299 are also common elements throughout the Display 200, 300, 360, 400, 450, and 500 according to one embodiment.

In one embodiment, Act Display 300 includes a view indicator 310 describing the style of the Act Display rendered. In the ActGrid view 310, the various actions associated with the SignatureDays Account are summarized by category. Box 316 indicates the number of High Severity Actions recommended for the SignatureDays account. Box 316 appears with a red background to signify the estimated large impact that the recommended actions will have on the SignatureDays Account. To further the assist the user box 316 includes an Impact Estimate 322 which details the estimated costs savings, new sales, and more clicks that are estimated to be achieved upon the user accepting the recommended actions and resolving the recommended alerts. One should appreciate that the impact on additional metrics may be estimated and displayed as part of an impact estimate display, as well as displaying the estimated impact on fewer or different metrics. Box 318 describes the actions and/or alerts that are of Medium Severity, and includes an impact estimate 324 detailing the estimated costs savings, new sales, and more clicks associated with taking the recommended action(s) and/or resolving the reported alert(s). In one embodiment, box 318 appears over an orange background to provide additional visual cues to the user of the importance of the displayed actions/alerts. Box 320 indicates the number of action/alerts that are of Low Severity and includes an Impact Estimate 326 detailing the estimated costs savings, new sales, and more clicks associated with taking the recommended action(s) and/or resolving the reported alert(s). Box 326 is highlighted by a yellow background in order to provide visual cues in addition to the displayed numbers the importance of the actions and alerts that fall into the Low Severity category. Box 314 provides the user with summary information for all potential actions and alerts related to the account that is being managed.

In one embodiment, header 328, organizes the individual alerts and actions for the account by Campaign, Ad Group, Keyword/Ad Copy, Severity, and Action. In this embodiment, a campaign is a collection of Ad Groups which in turn contain one or more Ads and one or more keywords, sharing the same budget. Campaigns may also share the same target language and location preferences. Globally, Campaigns are used to help organizes the advertising metrics into manageable elements, by forming part of a hierarchical organization of information associated with managed ads. In one embodiment the organization may be described by layers with keyword(s)/Ad copy as the base, Ad Groups form the next layer, and Campaigns hold the Ad Groups, and so on. Different categories may be employed to organize information associated with managed ads, and layer may be drawn at different levels of detail.

By default the recommended action list 330 appears sorted by severity with High Severity Actions appearing first, Actions/Alerts 331-335, with Medium and Low Severity Actions, 336-339, appearing afterwards. In one embodiment, background color for each action/alert 330-339 provides a visual cue to highlight the importance of the action/alert 330-339. Each heading in the Header 328 may be used to sort the Action List 330. One should appreciate the background color changes for each action based on its severity, in order to highlight the actions and alerts that are estimated to have a greater impact on the advertising account. However, other methods of visually highlighting the information displayed may be employed. In one embodiment, act 331 provides a user with a recommended action for the San Francisco—Local campaign. This example of an action contains additional information related to the campaign in order to enable the user to understand what elements of the campaign are implicated, what should be done to improve the campaign, and severity of the action. In this example, the display includes the Ad Group, Keyword/Ad Copy, Severity, and a summary of the action. Action 331 includes an Act button 340. Actions and alerts that appear in the Action List will typically have a button 340-349 that brings the user to a resolution screen for that action or alert. One should appreciate that such a link can take any form, and should not be limited to a button.

According to one aspect, the Act Display is designed to allow a user to quickly and effectively take actions and/or resolve alerts for an advertising network through a visual interface. The Act Display organizes, summarizes, and visually displays recommendations for actions and/or displays alerts of importance for a selected advertising network. The Act Display presents an interface summarizing information related to taking action and/or resolving alerts for an ad network. The Act Display focuses on information related to actions and alert, thus presents more detail related to actions and alerts than, for example, the dashboard display. Important actions/alerts are highlighted, drawing a user's attention using visual cues (color, size, font, border, etc.), and recommended actions are presented (alone and in summary format) where they exists. The Act Display effectively streamlines the resolution of actions and/or alerts of a viewed advertising network, provides tabs/references/links to quickly do the same for other managed networks in the management account, as well as tabs/references/link to access additional detail related to recommended actions and/or alerts.

In one example, action 331, provides the recommendation to “Edit Ad Copy.” The Analysis Engine 602, FIG. 6, in one example, identifies areas of the advertising network where actions are appropriate based on analysis of the advertising metrics supplied by the Advertising Network Data Feeder 610 from Advertising Networks 612-616 and maintained at Consolidated Network Repository 608. The Action Engine 606 determines what action or alert is appropriate for each area identified by the Analysis Engine 602 and the Visualization Engine 604 renders the action item or alert in the form appropriate to the potential impact estimated by the Analysis Engine 606. One should appreciate that according to one aspect, the management system relies on the integrated function of the Analysis Engine 602, the Visualization Engine 604, and the Action Engine 606. The integration of the three engines may occur as one engine that performs all three functions, or two engines or more. The present invention should not be interpreted as limited to the system 600, described in FIG. 6, as it should be appreciated that other systems having different architecture could be used.

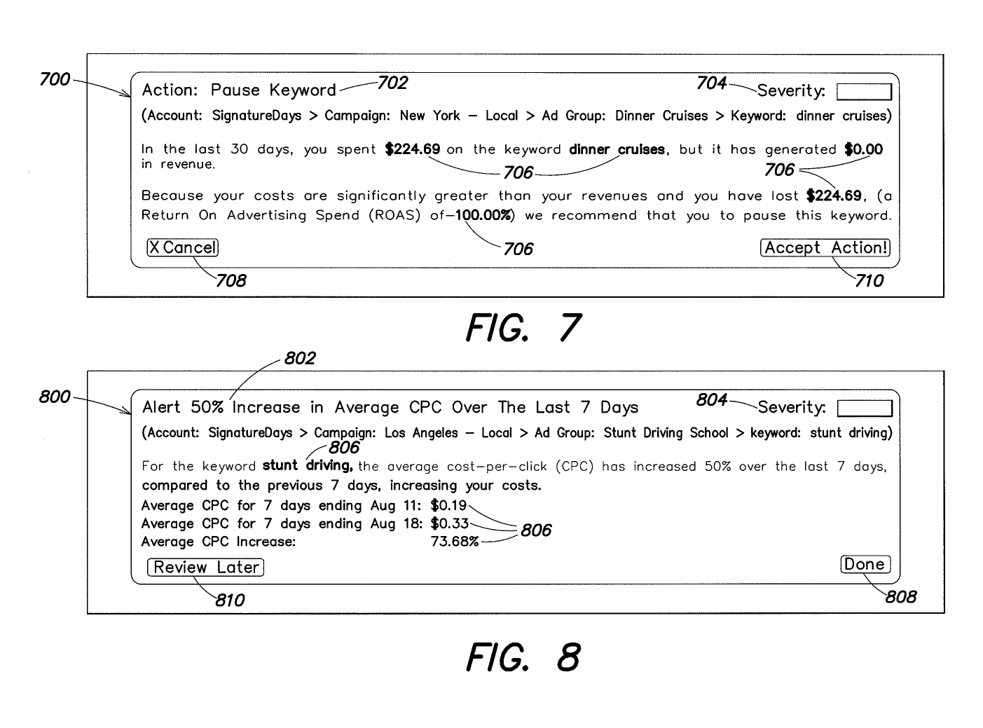

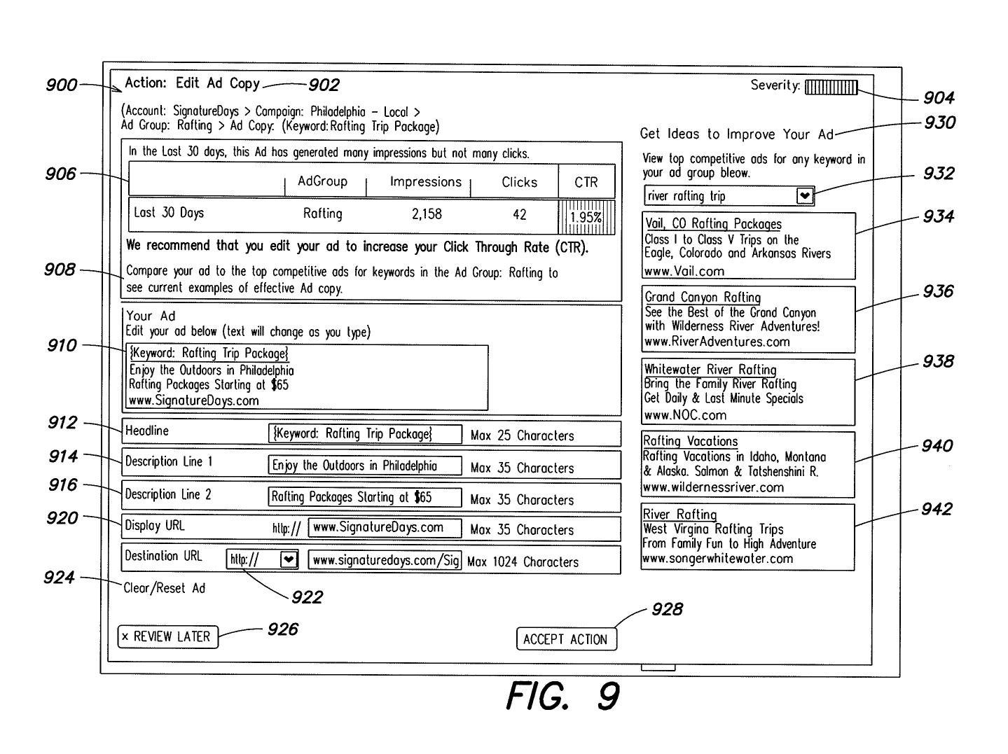

The example of an Action 331, includes an Act button 340. In response to a click on the Act button 340, the recommended action is displayed for the user in a resolution window. FIGS. 7-9 show embodiments of resolution windows for actions and alerts, e.g. Pause Keyword 700 FIG. 7; Increase Max CPC 800 FIG. 8; and Edit Ad Copy 900 FIG. 9. Additional actions and alerts include Increase In Average CPC; Inactive Keywords, Decrease in Revenue, and Edit Landing Page, all of which may include estimates related to improving performance.

In one embodiment, cost per click is an advertising metric, and its increase by predefined percentages triggers alerts, for example, 25% increase, 50%, 75%. Alternatively, a user may be provided with the option of configuring the ranges over which an alert will be generated. According to another embodiment, Inactive Keywords occurs when a maximum bid per click does not meet the minimum required to pay for a particular ad. In essence, the advertiser hasn't offered/bid enough to have the advertisement posted. In one example, an alert for Inactive Keywords is generated in response to the following criteria: (1) #KW.MinCPC>#KW.MaxCPC and #KW.MaxCPC!=0 OR (2) #K.MinCPC>#AG.MaxCPC and #KW.MaxCPC=0; AND (3) #K.Paused !=1; (4) #K.AdGroupStatus in (‘Active’,‘Enabled’); and (5) #K.CampaignStatus=‘Active’, although other criteria may be used in different examples. According to another embodiment, Decrease in Revenue alerts a user to a reduction in revenue for a particular ad, keyword, ad copy, ad group, campaign, and/or ad network. In one example, a Decrease in Revenue alert is generated in response to the following criteria: For the AdGroup (1) 0.75lastweek(*Getdate( )-8 and Getdate( )-14*).Revenue>=Thisweek(Getdate( )-1 and Getdate( )-7*).Revenue; (2) lastweek.Revenue>=0.01*(@AccountRevenue for lastweek); and (3) AdwordsType=‘Search Only’, although Decrease in Revenue alerts may be triggered on specific Keywords as well as AdGroups (or any other organizational level) and may be set to different percentages, as alternatives to the example's 25% reduction threshold. Another alternative, includes use of different time periods, as opposed to the use of one week. Another embodiment alerts a user to increases in revenue as well. In one example, the Increase in Revenue alert is triggered in response to the following criteria: (1) Thisweek(Getdate( )-1 and Getdate( )-7*).Revenue>=1.25*lastweek(*Getdate( )-8 and Getdate( )-14*).Revenue; (2) lastweek.Revenue>=0.01*(@AccountRevenue for lastweek); (3) AdwordsType=‘Search Only’; (4) AdGroupStatus in (‘Active’,‘Enabled’); and (5) CampaignStatus=‘Active’. An example alert window may contain a table showing for the time period: Avg CPC, Avg Position, Clicks, Cost, Revenue, and ROAS, although fewer and/or other metrics may also be displayed.

According to one embodiment, Edit Landing Page identifies an ad with underperforming conversions. Alternatively, Edit Landing Page identifies a low quality score for a page, or may include both measures. In one example, the ad is receiving a number of clicks bringing potential purchasers to the web page that the advertiser wants them to visit (i.e. the landing page), but the potential purchasers are not performing the actions on the page that the advertiser wishes (e.g. purchase, fill out survey, etc.). According to one embodiment, modifying the landing page will increase conversions, and the management system is configured to assist the advertiser in modifying the landing page. In one example, the management system assists a user by displaying competitive ads with the landing page, and by clicking on keywords within the competitive ads their landing pages are displayed. The display of competitive landing pages identifies different presentation and arrangements that are displayed by the management system because of better conversion rates. In one example, a recommendation to Edit Landing Page is displayed in response to the following criteria: (1) #AG.Impressions>0; (2) #AG.Ctr>@HighCtr; (3) #AG.Impressions>@AvgImpressions; (4) #AG.Conversion>0; (5) #AG.Conversion<@AvgConversion; (6) #AG.NwXrefStatus in (‘Enabled’,‘Active’); (7) #AG.CampaignStatus=‘Active’; and (8) #AG.AdwordsType=‘Search Only’.

In another embodiment, Add Keywords is a recommendation delivered by the management system. The recommendation to add keywords may be made dependent on whether the daily budget for a particular ad, keyword, ad copy, ad group, campaign or network would cover the additional spending on new keywords. In one example, an alert to add new keywords is generated in response to the following criteria: (1) Total Active @ KeywordCount in Account<2000; (2) Keyword counts in Adgroup<25; (3) Ag.NwXrefStatus in (‘Enabled’,‘Active’); (4) Ag.ProressStatus=‘Completed’; and (5) CampaignStatus=‘Active’.

Other recommendations include Add New Ad, where metrics indicate a new add will generate additional revenue, or the recommendation may be keyed to the number of ads in a particular ad group.

According to one aspect, actions and/or alerts may provide for user input as to the importance of an action and/or alert. In one embodiment, actions and/or alerts include and ignore feature, which will clear the action or alert without action and/or resolution. In another embodiment, the clearing of the action or alert will prevent that particular action/alert from appearing again. Alternatively, the action/alert is clear for a period of time, and if the conditions persist will be triggered again. According to one embodiment, actions/alerts include a user option to indicate whether the user wishes to receive more or less of the type of action/alert. A more selection will affect the threshold determinations for that type of action/alert so more of that type of action/alert will be display. A less selection will have the opposite effect. Various actions and/or alerts may also be associated with tutorials educating a user on how to alter ads, keywords, ad groups, campaigns, and/or networks to achieve particular effects on advertising metrics.

According to one aspect, the management system may define a number of thresholds for use in analyzing advertising metrics. In some examples, exceeding a thresholds triggers an action and/or alert recommendation. In other examples, not reaching a threshold triggers an action and/or alert. Some examples of threshold calculation follow, although one should appreciate that the threshold examples may be varied, may be used individually and/or in combination, and different threshold may be defined.

“@LowImpressions” may be used to describe a minimum number of impressions needed to analyze the keyword. One example for @LowImpression calculation is: (sum(impressions)/count(distinct(keywordid)))/(LOWCONSTANT). In one embodiment the calculation sets identifies half the average number of impressions for the keyword for the given date range.

“@HighImpressions” may be used to describe a minimum number of impressions needed to analyze the keyword. One example for @High Impressions calculation is: sum(impressions)*(HIGHCONSTANT)/count(distinct(keywordid)). In one embodiment, the calculation identifies twice the average number of impressions for the keyword for the given date range

“@LowADImpressions” may be used to describe a minimum number of impressions needed to analyze the AD. One example of a calculation includes: (sum(impressions)/count(distinct(textcreativeid)))/(LOWCONSTANT). In one embodiment, the calculation identifies half the average number of impressions for the AD for the given date range

“@HighADImpressions” may be used to describe a minimum number of impressions needed to analyze the AD. One example of a calculation includes: sum(impressions)*(HIGHCONSTANT)/count(distinct(keywordid)). In one embodiment, the calculation identifies twice the average number of impressions for the AD for the given date range

“@LowCTR” may be used to describe a minimum click through rate to analyze a keyword. An example calculation includes: ((cast(sum(clicks) as float))/(cast(sum(impressions) as float)))/(LOWCONSTANT). In one embodiment, the calculation identifies half the average of CTR for the keyword for the given date range.

“@HighCTR” may be used to describe a minimum Click Through Rate needed to analyze the keyword. In one example a calculation includes: ((cast(sum(clicks) as float))/(cast(sum(impressions) as float)))*(HIGHCONSTANT). In one embodiment, the calculation identifies twice the average of CTR for the keyword for the given date range

“@LowRTS” may be used to describe a minimum Revenue per Transactions needed to analyze the keyword. In one example, a calculation includes: ((cast(sum(TotalValue)as float))/(cast(sum(Transactions) as float)))/(LOWCONSTANT). In one embodiment, the calculation identifies half the average of RTS for the keyword for the given date range.

“@AVGRTS” may be used to describe a minimum Revenue per transactions needed to analyze the keyword. In one example, a calculation includes: ((cast(sum(TotalValue)as float))/(cast(sum(Transactions) as float)))*(HIGHCONSTANT). In one embodiment, the calculation identifies twice the average of RTS for the keyword for the given date range.

“@LowADCTR” may be used to describe a minimum Click Through Rate needed to analyze the AD. In one example, the calculation includes: ((cast(sum(clicks) as float))/(cast(sum(impressions) as float)))/(LOWCONSTANT). In one embodiment, the calculation identifies half the average of CTR for the AD for the given date range.

“@ HighADCTR” may be used to describe a minimum Click Through Rate needed to analyze the AD. In one example, the calculation includes: ((cast(sum(clicks) as float))/(cast(sum(impressions) as float)))*(HIGHCONSTANT). In one embodiment, the calculation identifies twice the average of CTR for the AD for the given date range.

“@LowPosition” may be used to describe a keyword in a low ranked position positions, which attract low attention. In one example, a calculation includes; sum(impressions*Pos)/sum(impressions)*(LOWCONSTANT). In one embodiment, the calculation identifies twice the average position for the keyword for the given date range.

“@HighPosition” may be used to describe keywords put in positions that are considered to be favorably ranked. In one example, a calculation includes: sum(impressions*Pos)/sum(impressions)/(HIGHCONSTANT). In one embodiment, the calculation identifies half the average position for the keyword for the given date range.

“@LowCost” may be used to describe a minimum Cost needed to analyze the keyword. In one example, the calculation includes: (sum(cost)/1000000)/count(distinct(keywordid))/(LOWCONSTANT). In one embodiment, the calculation identifies half the average cost for the keyword for the given date range

“@HighCost” may be used to describe a minimum Cost needed to analyze the keyword. In one example, a calculation includes: (sum(cost)/1000000)/count(distinct(keywordid))*(HIGHCONSTANT). In one embodiment, the calculation identifies whether analyzed element meets twice the average cost for the keyword for the given date range

“@LowADCost” may be used to describe a minimum Cost needed to analyze the AD. In one example, a calculation includes: (sum(cost)/1000000)/count(distinct(textcreativeid))/(LOWCONSTANT). In one embodiment, the calculation identifies whether analyzed element meets twice the average cost for the AD for the given date range.

“@HighADCost” may be used to describe a minimum Cost needed to analyze the AD. In one example, a calculation includes: (sum(cost)/1000000)/count(distinct(textcreativeid))*(HIGHCONSTANT). In one embodiment, the calculation identifies whether analyzed element meets twice the average cost for the AD for the given date range

“@LowConversion rate” may be used to describe a minimum number of conversions required per click to analyze the keyword. In one example, a calculation includes: ((cast(sum(conversions) as float))/(cast(sum(clicks) as float))/(LOWCONSTANT). In one embodiment, the calculation identifies whether analyzed element meets Half the average conversion rate for the keyword for the given date range

“@HighConversion rate” may be used to describe a minimum number of conversions required per click to analyze the keyword. In one example, a calculation includes: ((cast(sum(conversions) as float))/(cast(sum(clicks) as float))*(HIGHCONSTANT). In one embodiment, the calculation identifies whether analyzed element meets twice the average conversion rate for the keyword for the given date range.

“@ LowADConversion rate” may be used to describe a minimum number of conversions required per click to analyze the AD. In one example, a calculation includes: ((cast(sum(conversions) as float))/(cast(sum(clicks) as float))/(LOWCONSTANT). In one embodiment, the calculation identifies whether analyzed element meets half the average conversion rate for the AD for the given date range.

“@HighADConversion rate” may be used to describe a minimum number of conversions required per click to analyze the AD. In one example, a calculation includes: ((cast(sum(conversions) as float))/(cast(sum(clicks) as float))*(HIGHCONSTANT). In one embodiment, the calculation identifies whether analyzed element meets twice the average conversion rate for the AD for the given date range.

“@LowConversionValueRate” may be used to describe a minimum sale required per click to analyze the keyword. In one example, a calculation includes: ((cast(sum(conversionvalue) as float))/(cast(sum(clicks) as float))/(LOWCONSTANT). In one embodiment, the calculation identifies whether analyzed element meets half the average conversion value per click for the keyword for the given date range.

“@HighConversionValueRate” may be used to describe a minimum sale required per click to analyze the keyword. In one example, a calculation includes: ((cast(sum(conversionvalue) as float))/(cast(sum(clicks) as float))*(HIGHCONSTANT). In one embodiment, the calculation identifies whether analyzed element meets twice the average conversion value per click for the keyword for the given date range

“@LowROAS” may be used to describe a minimum return required to analyze the keyword. In one example, a calculation includes: (((cast(sum(conversionvalue) as float))−(cast(sum(cost)/1000000 as float)))/(cast(sum(cost)/1000000 as float)))/(LOWCONSTANT). In one embodiment, the calculation identifies whether analyzed element meets half the average ROAS for the keyword for the given date range.

“@HighROAS” may be used to describe a minimum return required to analyze the keyword. In one example, a calculation includes: (((cast(sum(conversionvalue) as float))−(cast(sum(cost)/1000000 as float)))/(cast(sum(cost)/1000000 as float)))*(HIGHCONSTANT). In one embodiment, the calculation identifies whether analyzed element meets twice the average ROAS for the keyword for the given date range

The various thresholds described above may be incorporated into an Act Engine, and may provide an overview of an example of a set of ActEngine Rules. The various calculations are examples of specific rules defined for one implementation of an action engine. The examples may include associated metrics, context for actions and/or alerts, calculations for determining whether criteria is met for the generation of actions and/or alerts, as well as examples of motivations/symptoms behind providing particular recommendations, definition of variables to be used in calculations, as well as formulas that may be employed. It should be appreciated that present invention should not be limited to the specific examples provided, and that examples are for illustration only and are not meant to be limiting. Other embodiments keyed to different details (metrics, symptoms, motivation, user explanation calculation, thresholds, variables, formula, etc.) in implementation are included in the present invention, as well as embodiments that omit certain of the features and/or details described in the examples.

In one embodiment, the management system recommends Reduce Bid for poorly performing keyword(s). In another embodiment, the management system may recommend re-organization of particular ads, keywords, ad groups, and/or campaigns. For example, use of specific keywords instead of broad keywords may improve performance of a particular ad, and in another example the use of broad keywords instead of specific may improve performance.

According to one embodiment, inactive keywords are monitored to determine if the keyword should be activated. The analysis engine 602 estimates the performance of the inactive keyword, in one example, by increasing the max cpc bid for the keyword. Where the max cpc increase results in a positive ROAS, the management system recommends activating the inactive keyword.

In another embodiment, additional alerts include a warning when the daily budget for an ad, keyword, ad copy, ad group, campaign, network approaches its limit. In one example, the management system generates an alert where 90% of the daily budget has been spent over a predefined time period (day, week, month).

In one example, an alert is generated when click fraud is suspected. Click fraud results from the clicking on an ad, which is measured as a click, where there is no intention to perform any acts on the ad's link. The measured click typically results in a cost for that click. Where the operator (a person, program, or script for example) does not intend to complete any action on the ad's link, this is a vehicle for abuse by competitors or the hosting party of the ad among others. By tracking metrics associated with the ad, clicks, impressions, etc. the management system can detect variations in averages, and variations in performance. Where certain thresholds are exceeded click fraud is implicated and an alert is generated.

Each action/alert may also have a priority assigned to it. The priority assignment enables the management system to quickly display actions/alerts on the basis of their priority as well as by estimated impact on the advertising network. The various types of actions/alerts may also have a priority assigned to them, so that, for example, increase max cpc displays before pause keyword. Actions and/or alerts may also be generated on the basis of the analysis of multiple metrics yielding actions/alerts that provide a number of options for resolution. In one example, low CTR may be resolved by refining matches (adding negative keywords will avoid untargeted expressions as well as making keywords more specific) or it may be resolved by improving ad copy. Thus an alternative action recommendation is generated. In one alternative, the user may perform all of the displayed options, some, or none.

TABLE I

| Priority | Recommendation Type |
|---|---|
| 1 | Action: Increase Max CPC: Grow revenue by raising bid for |
| | keyword that is performing well. |
| 2 | Action: Reduce Bid (Max CPC): Reduce your bid to improve |
| | your returns. |
| 3 | Action: Pause Keyword: Save costs by pausing ineffective |
| | keyword that is performing poorly. |
| 4 | Action: Edit Ad Copy: Add clicks by editing ad copy to increase |
| | click-through rate. |
| 5 | Alert: Edit Landing Page: Improve your quality score and CTR |
| | by editing landing page. |
| 6 | Alert: 50% Increase In Average CPC Over The Last 7 Days. |
| 7 | Alert: Keywords Have Become Inactive For Search. |
| 8 | Action: Add Keywords: Increase number of keywords to |
| | improve advertising effectiveness. |
| 9 | Alert: 25% Decrease In Revenue Over The Last 7 Days. |
| 10 | Alert: 25% Increase In Revenue Over The Last 7 Days. |

Table I illustrates an example of priorities assigned to examples of actions and alerts. One should appreciate that Table I is provide by way of example and not by way of limitation, other priority levels may be assigned, and different actions and alerts may be assigned different priority levels, in different alternatives.

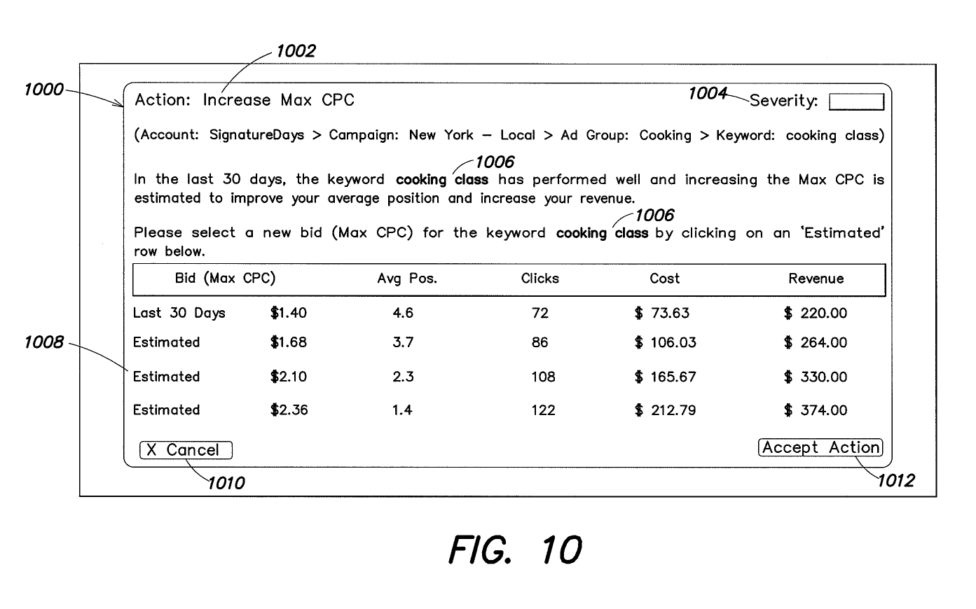

The Act Display 300 may also be displayed to the user as a map of the ad campaigns that make up the account. FIG. 3B, shows the ActMap Display 360, the display title 362 displays to the user the type of view, ActMap, and the account being reviewed, SignatureDays. In an alternative embodiment, ActMap Display 360 is reached by selecting 350 switch view to ActMap. In one embodiment, drop down menu 364, provides the user with the option of configuring the ActMap 368 to displays with respect to various metrics. In this embodiment the user's choices include Cost, Impressions, Clicks, CTR, Conversions, Conv. Rate, Revenue, and ROAS. One should appreciate that many different metrics may be included in the drop down menu, some metrics may be omitted and the invention should not be limited to the particular list discussed above. Legend 366 details what the colors signify in the Map 368. In one embodiment, red is associated with a High Severity, orange with Medium, yellow with Low, and grey indicates that no recommended action or alert exits for a particular element on the Map 368. In one embodiment, both the size and color of elements are significant in the ActMap view. In this embodiment, the block size indicates the performance for the metric selected in the drop down menu 364 and the color indicates the impact of the recommended action. In response to the user clicking on an element of the Map 368, for example Action 370 for “Dinner Cruises,” a balloon will appear describing the particular action to be taken. In one embodiment, balloon 372 details the recommended action, Increase MaxCPC, and provides metrics to assist the user in managing the ad, keyword, ad group, or campaign displayed. Within balloon 372 appears an Act button 374, which brings the user to a resolution window 1000, FIG. 10. Although no recommended actions or alerts exist for the elements of the Map shown in grey, clicking on them generates a balloon 376 that provides additional detail on the metrics related to that element. In this embodiment, shown is two balloons appearing on the display of Map 368, typically, only one balloon will be shown at a time, however the system may be configured to display multiple balloons, and/or to require the user to take an affirmative act to close the balloon, for example, by clicking on the “X” in the upper right corner of a balloon. In an alternative embodiment, balloon displays are linked with a timer and if no action is performed with respect to the balloon the specified time the window is no longer displayed. If the user is more comfortable with the ActGrid presentation, the switch view button 378, takes the user to Act Display 300, FIG. 3A in response to a mouse click.

According to one aspect, the Act Map provides a visual summarization of actions that may be taken with a particular advertising network. The display is user-friendly and uses visual cues to emphasize particular actions (size, shape, and color of boxes for example). According to another aspect, the interface facilitates quick action by displaying additional windows in response to events, and providing tabs/references/links/buttons to bring a user to additional detail needed to resolve actions and/or alerts. The Act Map also provides a user with configurable options, in order to provide information visually that a user may require in managing a plurality of advertising networks.

With respect to FIG. 4A shown is an embodiment implementing various aspects, on of the Manage Display 400. Display title 402 indicates the type of Display—Manage Account and the account SignatureDays. Display 404 provides a summary of recommended actions/alerts for this account, categorizing them by severity. Box 432 provides a link to Act Display 300, and further provides for Act Display 300 to only show High Severity Actions/Alerts in action list 330. Box 434 and 436 provide similar links to the Act Display 300, each filtering Medium and Low Severity Actions/Alerts accordingly. Display 406 provides quick trend analysis for the user. Display 408 provides for user selection of a particular metric to display and 410, provides for the user to configure a date range over which to view the selected metric. Menu 432 also provides for the configuration of date ranges.

Display 412 displays the overall performance for the metrics being analyzed in the account. In this example the metrics include Impression, Clicks, CTR, Cost, Conversions, Conv. Rate, Revenue, and ROAS. Display 412 may be configured to display the metric data from the beginning of the account, or for a particular date range, one option includes tying range of dates for display 412 to the range of dates selected in 410 or optionally to Menu 432. An additional option includes a selectable date range for Display 412 (not shown). Header 414 organizes the display of the campaign list 418 associated with the SignatureDays account. By default, the list is organized by Campaign, however a user may select any of the headings in the Header 414: Campaign, Status, Daily Budget, Imp. (Impressions), Clicks, Avg CPC, and Cost.

According to one embodiment, additional information may be displayed for a particular campaign in response to the user rolling the mouse pointer over the particular campaign. For example, balloon 432 displays in response to a mouseover event on campaign 420 “Boston—Loca . . . ”. The balloon 432 in this embodiment is configured to display the full name of the ad campaign, and can be configured to display additional information related to the campaign. Button 422 displays information on whether the associated campaign 420 is action or inactive. Button 422 may be toggled “On” or “Off” by the user in response to mouse clicks. The daily budget display 424 is also editable directly from the Manage Account Display 400. Providing this functionality with summary information assists a user in making decisions related to the Ad Network.

The Manage Account Display 400 also includes Tools 416 that may be used in conjunction with the account being managed. Further the user is provided with the option of selecting from multiple account with expander 426. In response to a click on 426, the Manage Account Display may be configured to display multiple accounts and permitted their selection in response to a mouse click. Expander 428, shows by line the total for active campaigns 429 and inactive campaigns 431, as well as providing for a user to add a new campaign 430. Display of the list associated with Campaigns 429-431 can be toggled in response to a click on expander 428 so as to display or not.

Clicking on Campaign 420, for example, brings the user to Manage Campaign Display 450, FIG. 4B. Display title 452 indicates the display type, Manage Campaign, and Campaign name, for example Atlanta—Local. Menu 456 provides the user the ability to change the viewed campaign by selecting from a drop down menu including the campaigns for the viewed account. Displays 458, 460, and 466 provide similar information as displays 404, 406, and 412 discussed above. Display 460 provides configurable options 462 and 464 that operate in the same manner as 408 and 410 respectively. In this embodiment, header 467 organizes the display of the detailed campaign information into categories: Ad Group; Status; Max CPC; Imp. (Impressions); Clicks; CTR; Avg CPC; and Cost. It should be appreciated the different metrics may be displayed to assist the user in managing any particular ad network or groups of networks.

Display 468 provides an interface for the user to access various tools associated with managing the ad campaign. Displays 470-475 include toggles 476-481 to expand and collapse information and tools related to the ad campaign. Display 470 details the Campaign being managed and provides the start date 483 for the campaign as well as any scheduled termination date, or the date on which the campaign was made inactive 484. Option 485 provides a calendar interface to the user for imputing a desire end date.

Display 471 provides information related to the budget for the selected campaign, as well as interface 486 for changing budget constraints. Display 472 provides information on the particular ad networks to which the selected campaign belongs. Using buttons 487-490 a user may configure how the campaign behaves with respect to the displayed ad network. Button 487 enables a user to toggle Google search “On” or “Off” with respect to the selected campaign. Button 488 toggles Network Search “On” or “Off” in response to mouse clicks. Display 473 shows information related to target language of the campaign, and a user may change the selection using field 491. Display 474 provides information on the geographical target of the selected campaign. The geographical targets are configurable using field 492. Display 475 provides information on the Ad Groups to which the campaign belongs. Field 493 enables a user to add additional groups to the viewed campaign.

In one embodiment, a user may navigate from the Manage Campaign Display 450 by selecting tab 208, for example. In response to selecting tab 208, the user is brought to the Analyze Display 500, FIG. 5A. Display title 502 indicates the display type, Analyze and the account being analyzed, SignatureDays. Interface 504 provides the user with configurable options for preparing, generating and viewing reports on the advertising network, campaign, Ad Group, and key word. A user may select from radio buttons 506-514 depending on the desired report. Metrics 506 shows a graphical representation of the sales funnel for the selected report target and date range. Trends 508 provides reporting on drift or tendency in campaign measurement and performance metrics. Performance 510 reports on how different Campaigns, Ad Groups and Keywords have performed during a certain period. Highest/Lowest Performance 512 describes the Best/Worst performing Campaigns, Ad Groups and Keywords against different performance metrics. Comparisons 514 reports on how two metrics compare against each other for a given advertising network account, campaign, ad group or keyword.

In one embodiment, drop down menus 516-520 enable the user to select multiple levels of detail for the report. In particular the user may select one or more advertising network accounts using drop down menu 516. In one embodiment, optional drop down menu 520 provides for a user to select all the campaigns associated with the ad network account or the user may select from individual campaigns listed. In another embodiment, optional drop down menu 517 provides for a user to select all Ad Groups associated with the selected campaign(s) or individual Ad Groups, and optional drop down menu 519 further refines the reporting to user selected Keywords. The date range over which the report will be run is also configurable, in this example as a drop down menu 522 for selecting date ranges. Button 524 executes the report for the user selected criteria and displays the results in window 526. The nature and display of the reporting window will change based on the user selected criteria, shown is the report generated for the Metric radio button 506.

Display 550, FIG. 5B, illustrates an embodiment of a report generated from the Trends 508 option. Display 550 includes a user configurable option 542 for displaying different metrics associated with the displayed graph. According to one embodiment, display 504 may vary depending on the report type select, for example, for Trends 508 an interval selection 540 displays, to allow a user to select an interval for the report.

Display 560, FIG. 5C, illustrates an embodiment of a report generated from the Performance 510 option. The report generated for the Performance option includes a drop down menu 562 to enable a user to select different metrics for graphical display. The Performance report also includes the performance breakdown 564 by day (the time interval is a user configurable option from drop down menu 540) detailing on a daily basis the performance over the associated metrics. According to one embodiment, optional drop down menu 568 enables a user to export the viewed report in a selectable format.

Display 570, FIG. 5D, illustrates an embodiment of a report generated for the Highest/Lowest Performers 512 radio button. The Highest/Lowest Performers report includes configurable options via drop down menus 572 for selecting a chart metric to review and 574 for selecting either highest or lowest performer for the selected metric. Display 580, FIG. 5E, illustrates an embodiment of a report generated for the Comparisons option 514. Display 580 includes drop down menus 582 and 584 to enable a user to select the desired metrics to plot against each other in the graph shown in display 580.

FIG. 6 is an illustration of an embodiment of a system for improving advertising conversions in accordance with various embodiments. The system for improving advertising conversions provides for the management of a plurality of advertising networks.

According to one embodiment, there are 3 engines that act in concert to minimize costs, maximize conversion quality, and manage advertising networks:

Analysis engine 602: This engine analyzes the raw advertising metrics defined above to identify where:
a. Advertisement Driver needs to be improved so that Impressions can be increased.
b. Advertisement Quality needs to be improved so that Clickthrus can be increased.
c. Conversion Process needs to be improved so that Conversions can be increased.
d. Advertisement Driver needs to be dropped so that Costs can be reduced.
e. Advertisement Quality needs to be improved so that Costs can be reduced.
f. Conversion Process needs to be improved so that Costs can be reduced.

Visualization engine 604: This is a Treemap based visualization that allows the user to visualize a tree in a 2-d space. Tree visualization with tree maps is described, generally, in the reference “Tree Visualization with Tree-Maps: 2-d space-filling approach”, ACM Transactions on Graphics in January 1992 (http://www.acm.org/pubs/citations/journals/tog/1992-11-1/p92-shneiderman/), which is incorporated by reference herein in its entirety.

The general teachings of tree map visualizations have been adapted to function in the context of Advertising systems and methods.

The treemap is customized as follows:
g. Each node reflects an Advertisement Driver (for example, a keyword, or some appropriate higher level grouping of keywords)
h. The size of a node is customizable to be any of the historical values of the metrics above (for example, the historical Cost to the advertiser for each keyword or banner ad).
i. The color of a node reflects the impact of the suggested recommendation. The impact could be in terms of any of the metrics above (for instance, a savings in costs of $2,000 will be a stronger color than a savings of $2 in costs.)
j. A mouseover on the node reveals detailed data on the node (such as historical trend of impressions on the advertisement driver) and the recommended action.
k. A click on the node or the mouseover window allows the user to bring-up the action engine.

Action Engine 604: The action engine is a rapid one-box recommendation (similar in spirit to the One-Click Purchase button on Amazon.com) that allows a user to take an action to improve its advertising campaign. The Action Engine in this invention:
a. Suggests a recommendation provided by the Analysis Engine 602 (for example, pause keyword ‘Red Shoes’.)
b. Gives the context of the recommendation (for example, the trend of costs and sales for ‘Red Shoes’).
c. Explains the rationale for the recommendation (for example, ‘Red Shoes’ has cost you $2,000 but has brought in $2 in revenues.)
d. A action-input box that allows the user to:
   i. Either accept or reject a recommendation using accept/reject buttons.
   ii. Or, alter recommended advertisement parameters (For example, if the Analysis Engine suggests that the user should pay $1.20 for a keyword, the user can go in and change it to $1.25.

The respective engines are operatively connected to Consolidated Network Repository 608, which maintains the advertising data feed to the system by Advertising Network Data Feeder 610, which receives raw advertising data from Advertising Networks 612-616. Advertising Network Data Feeder 610 may perform queries associated with Advertising Networks 612-616, and in some embodiments be associated with a web crawler/robot to obtain information related to advertisements. In one embodiment, Advertising Network Data Feeder 610 is configured to import existing advertisements. Data Feeder 610 accepts information related to existing ads in order to perform queries or accept information relations to particular ads. In one embodiment, Consolidated Network Repository 608 is implemented as a single database with multiple instances. However, one should appreciate that the repository may be implemented as multiple databases, or may be implemented as any other type of data repository and may be configured as a sever with respect to multiple clients.

With respect to FIG. 7, illustrated in embodiment of a resolution window 700 for either accepting or rejecting the recommended action. In this embodiment, shown in display title 702 is the type Action, and the specific action recommended: Pause Keyword. 704 identifies the severity level of the associated action. Optionally, specific words are shown in bold, 706, in order to highlight information that formed the basis of the recommended action. A user may accept the recommended action by clicking button 710 or reject the recommendation and click on the cancel button 708.

With respect to FIG. 8, shown is an embodiment of a resolution window 800, where the recommendation comes in the form of an Alert. Display title 802 details the type: Alert, and the metric that triggered the Alert: Increase in CPC. 804 indicates the severity of the Alert. Certain information in resolution window 800 is optionally highlighted in bold 806 as a visual cue to draw the user's attention to the information that formed the basis of the recommendation. The user may indicate to the system that the Alert has been received by clicking button 808, or the user may maintain the alert as active by selecting the button 810. One should appreciate that for various actions and alerts that information may be highlighted in more than one way. Shown by example, is the use of bold text, however, the arrangement of the text itself may also be used to highlight information, as well as the use of highlighting or other visual cues. In one example, an alert is triggered in response to the following criteria: (1) Thisweek(Getdate( )-1 and Getdate( )-8).AvgCPC>1.5×lastweek(*Getdate( )-9 and Getdate( )-16*).AvgCPC; (2) lastweek.AvgCPC !=0; (3) Thisweek.KeywordStatus=‘Active’, Thisweek.AdGroupStatus in (‘Active’,‘Enabled’), Thisweek.CampaignStatus=‘Active’; and (4) Lastweek.KeywordStatus=‘Active’, Lastweek.AdGroupStatus in (‘Active’,‘Enabled’), Lastweek.CampaignStatus=‘Active’. The example uses one week as a time frame, however, one should appreciate that different time periods may be used for analysis and generating alerts.

With respect to FIG. 9, one embodiment of a resolution window 900 describes the type of suggested action recommended Action, and the Action recommended “Edit Ad Copy at display title 902. The severity of the recommended action is display at 904. Resolution window 900 provides details associated with the particular action: over the date range—30 days; the ad within the ad group—Cooking, had measured Impressions of 6,628, but the Clicks obtained from those Impression number only 181 for a CTR of 2.73%. As determined by the Analysis engine 602, improving the Ad copy should result in increased click-through rate (CTR). Display 910 illustrates the current ad copy, which may be edited using boxes 912-922. Resolution window 900 includes an option validation features for validating display url 920 and 922 destination url. In one example, a recommendation to Edit Ad Copy is presented in response to the following criteria: (1) #Ad.Impressions !=0; (2) #Ad.CTR<=@AvgADCTR; (3) #Ad.Cost>@HighADCost; (4) #Ad.Impressions>@HighADImpressions; (5) #Ad.NwXrefStatus in (‘Enabled,‘Active’); (6) #Ad.AdGroupStatus in (‘Active’,‘Enabled’); (7) #Ad.CampaignStatus=‘Active’; and (8) #Ad.AdwordsType=‘Search Only’. Other examples may use different criteria, which may include one, some, or none of formulas (1)-(8).

According to one embodiment, in order to assist the user in designing better Ad copy, the system suggests ideas at 930. Using drop down menu 932 a user selects keywords associated with the ad copy, and the system provides the top competitive ads 934-942 for those particular keywords. Once the user enters changes, the changes are committed by selecting button 928, or the user may discard the changes by selecting the cancel button 926. Further, a user may reset the ad copy by selecting 924.

With respect to FIG. 10, illustrated in an embodiment of a resolution window 1000. Display title indicates the type: Action and the act: Increase Max CPC. The severity determined by the analysis engine 602 is reported at 1004. Optionally, certain information is highlighted in resolution window 1000 by displaying text in bold at 1006 as a visual cue to bring the user's attention to information relevant to the action. Other visual cues may be employed. The analysis engine 602 provides estimates of the potential impact of increased bids on revenue, as well as other metrics, and the action engine 606 provides context for the analyzed data. The user may select a new Max CPC by clicking on a row in the recommend bid table 1008 and then by clicking on the accept button 1012. Optionally, the resolution window may only display any number of recommendations regarding increase on spending, from as few as one to an unlimited number. The user may also disregard the recommendation by clicking on the cancel button 1010.

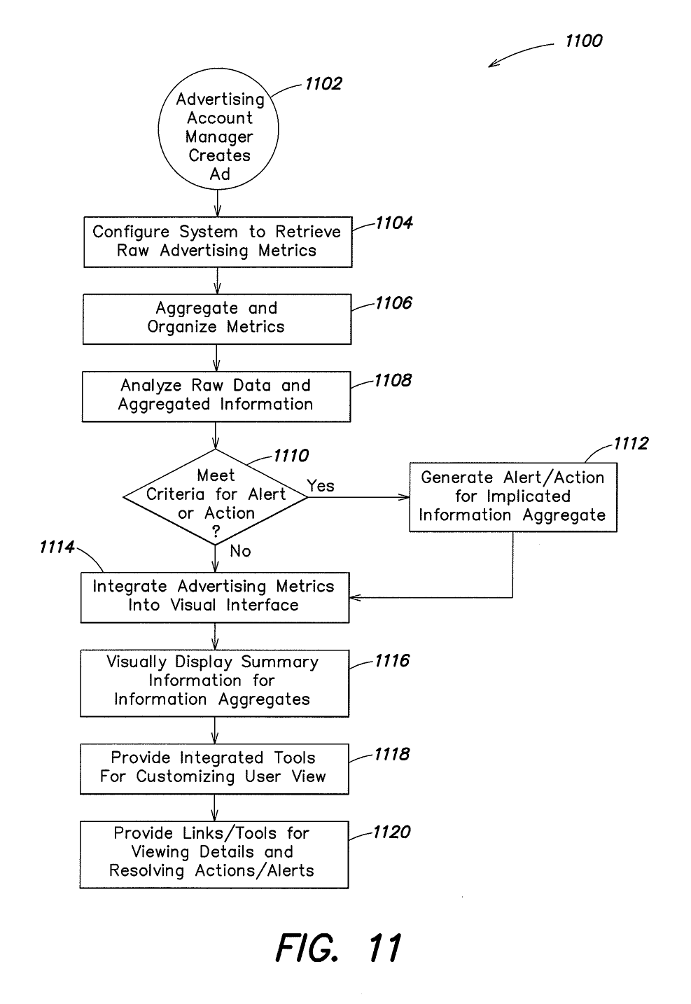

With respect to FIG. 11, shown is an embodiment of a process 1100 which illustrates a method for managing a plurality of advertising networks in accordance with aspects of the present invention. At step 1102, an advertising account manager creates a particular ad. Step 1102 may also be performed by bringing an existing ad into a system for managing a plurality of advertising networks. At step 1102, the manager/user of a system for managing a plurality of advertising networks may create a number of ads across a number of advertising networks. One should appreciate that the management system should not be limited to a system where a plurality of networks have been configured but should include a system where a single network has been configured and other networks may be added.

According to one embodiment, step 1104 occurs automatically in response to the user/manager creating new advertisements using a system for managing a plurality of advertising networks. Step 1104 may require some action on the part of the user/manager where the advertisement is preexisting. In the circumstance where action is required, the user/manager simply identifies the advertising network where the advertisement exists and provides information related to the ad. After the information has been entered, the management system automatically tracks existing advertisements. In one embodiment, an advertisement network data feeder supplies advertising metrics for the related ads.

At step 1106, the advertisement metrics are aggregated in a central repository and associated with their respective elements e.g., account, network, campaign, ad group, keyword/ad copy, and ads. In one embodiment, the element are organized into a hierarchical structure, with the advertising network forming the root of the hierarchy, then advertising campaign, ad group, keyword/ad copy, and the ad itself. Arranged hierarchically the elements and associated metrics are made easy to analyze in step 1108. The analysis may include tracking historical performance over specified time ranges, where both the system and a user/manager can specify time ranges to analyze and the analysis may also include comparisons between metrics, as well as between existing advertisements.

Based on the analysis of the advertising metrics, it is determined whether or not any of the aggregated information meets criteria for generating a recommended action/alert, at step 1110. If the criteria is met 1110(YES) then an action/alert is generated describing the actions that will improve an ad, keyword, ad copy, ad group, campaign, network, or account at step 1112.

If the criteria is not met 1110(NO) advertising metrics are integrated into the visual display of the management system interface at 1114. The display of the advertising metrics typically occurs in as a visual summary to facilitate use by the user or manager. Moreover, the integration of advertising metrics into the visual display may occur at different points of process 1100 and need not specifically occur at step 1114.

Step 1114, is also reached after an alert/action is generated. The action/alert is integrated into the visual interface, in a similar manner as the advertising metrics, although typically the amount of summarization that occurs for actions/alerts will be reduced as the volume of information for actions/alerts will typically be significantly smaller than that associated with the advertising metrics. However, summarized presentation may occur, for example, where multiple actions/alerts exists in a particular category. The categories may include severity level, action type, alert type, or may be summarized and/or grouped according to what element is associated with the action/alert. In one particular embodiment, the summarized presentations are rendered in multiple occurrences at 1116, each summarizing the information at different levels in different ways. In one example, a severity summarization bar is rendered at 1116, identifying the total number of actions/alerts for the viewed account, and further displays each severity category with the number of actions/alerts in each. In another embodiment, each categorized summary is highlighted with a visual cue related to an estimated impact the action/alert will have on the account. In addition, another instance of visually displaying summary information may occur in the form of rendering the actions/alerts as an action/alert list at 1116, with each element of the list identifying a type, action/alert, the action to be taken, for example increase max CPC, and a view button to bring the user to a more detailed view. It should be appreciated step 1116 should include any number of visual displays of summarized information and also that information may also appear in unsummarized format, for example, the action/alert list may also appear in an unsummarized format to provide immediate user access to a listed action and/or alert.

As part of the visual display, the user will be provided will tools for customizing the view of information at 1118, including options to change the summarization of information. For example, a tool provides a user/manager the option of changing the date range over which information is displayed, other tools may provide the option of viewing particular subsets of information at 1120, increasing the level of detail, resolving actions/alerts, still other tools may provide for navigating the visual display, changing the metrics viewed, comparing the metrics view, soliciting recommendations, among others functions. The user/manager is given the option of accepting or rejecting recommendations made on an account, ad network, campaign, ad group, keyword, ad copy, or ad using the provided tools. The links/tools typically render summary information associated with the particular action, so layered suggestions may be made each with an associated estimated impact on the account, etc. Where the user accepts the recommended action or resolves the alert through the provide tool, the user will have improved for example conversion of advertisements for the account. In an embodiment, where a plurality of advertisement networks has been configured, the user manages the plurality of networks by repeating at least some of the steps of process 1100 for additional advertising networks.

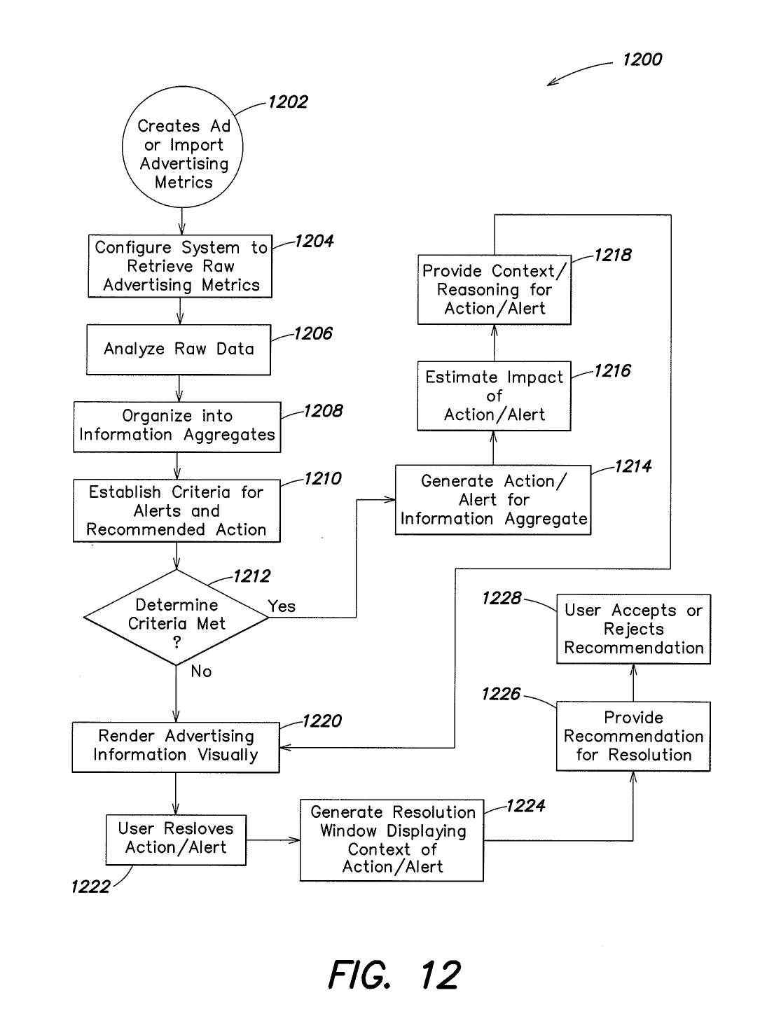

With respect to FIG. 12, shown is an embodiment of a process 1200, which described in greater detail a method for managing a plurality of advertising networks whereby advertising conversions are improved. At step 1202 a user (who may be manager of an advertising account) creates an ad. Step 1202 also includes importing existing ads into the management system. Multiple ads and their associated information may be created and imported. Where ads are imported into the management system some action on the part of the user is typically required at 1204. Such action involves configuring the management system to received raw advertising metrics associated with the ad. In one example, configuration is performed by inputting information related to the advertising network currently hosting the ad, for example, the well known Google adWords, or the well known Microsoft “adCenter,” among others. The user may be required to assign a campaign name to the ad, as well as, identify the keyword, ad copy, associated url, etc. The system may also be configured to automatically retrieve the information, and permit the user to correct errors.

At step 1206, the data is analyzed and the information associated with the advertising network is organized into information aggregates at 1208. Aggregated information is used in association with the rendering of the advertising network visually, as discussed in greater detail with respect to step 1220. At step 1210 criteria is established for alerts and actions to be taken on the advertising network. By default certain criteria are pre-established by the management system, for example, where the return on investment for a particular ad shows a complete loss over a predefined period of time (for example one month) the system determines that this particular ad meet the criteria for a pause keyword act at 1212(YES). An alert will be generated at 1214 and the impact on the network will be estimated or measured at 1216. In this example, the impact on the network is easy to estimate/measure, by pausing the keyword a user stops the spending on that particular keyword and improves overall performance for the network. Context information is associated with the action at 1218, which in this embodiment, includes reasoning based on saving money that is not producing any positive action or return. The context information may also include the amount spent, and other metrics that support a decision to pause the use of the particular keyword.

Another example includes, criteria for increasing max cpc. Where an ad is performing well (positive return on investment as one measure), and has a low average position (average position is typically ranked in order of appearance on for instance a web page) the criteria is met for an increase max cpc action at 1212(YES). In response to determining criteria is met an action/alert is generated at 1214. The impact of an increase in max cpc is estimated at step 1216. For particular actions involving increased spending, the estimate occurs incrementally providing a user choices between increased levels of spending on a particular ad. In addition, the estimation may include a metric to indication of the rate of return for additionally spent funds, i.e. detailing the margin of return on money spent. For example, a user's decision is impacted by the fact that even though additional funds will increase revenue for an ad, the amount of money spent does not increase the revenue by an equal or greater amount, reflecting a negative margin.

Default criteria may also include generating alerts based on changes in analyzed metrics, for example, an increase in average CPC by 50% over a predefined time period will meet criteria at 1212(YES) for an alert “50% increase in CPC” and the alert will be generated at 1214. The impact of resolving the alert will estimated at 1216 and the context for the alert is associated with the alert at 1218. For alerts that do not have an associated impact the account step 1216 may be omitted.

Step 1212(NO) and 1218 both lead to step 1220 where advertising information is rendered visually in the management system. However, where no actions/alerts exist, step 1220 represents the end of process 1200. One should appreciate that process 1200 is illustrated for convenience as a linearly executed flow, where in actual operation the steps of process 1200 may be repeated, run continuously (for example 1206 analyze data), and executed in different order. Step 1220, in one embodiment comprises rendering the advertising information associated with at least one of a plurality of advertising networks as a two dimensional tree. The two dimensional tree is a treemap of a webpage where each element of the tree is a node, and each particular node represents a hierarchical arrangement of the advertising data associated with the at least one of the plurality of advertising networks.

Where actions/alerts do exist, step 1220 includes rendering actions/alerts visually. A visual representation of an action/alert provides the user with an interface for resolving the action/alert. At step 1222, the user selects a link/reference to resolve the action or alert, in the case of actions, resolution may occur by accepting or rejection the recommendation, and in the case of alerts, the user simply indicate that the alert has been reviewed in order to resolve it. At step 1224, a resolution window is displayed which provides the action/alert and its associated context to the user. The associated context provides the user with information to enable the user to determine whether to accept or reject the recommended action is necessary. At step 1226, a recommendation is displayed for resolving the recommended action/alert. For example, a recommendation to edit ad copy may be accompanied by an option for the user to select recommendation as to how to edit the a copy. In the example, the option may be keyed to any of the ad's content, such as keywords. The user may select a particular keyword and receive recommendation in the form of a presentation of other ads related to that keyword that are performing better. At 1228, the user accepts or rejects the recommendation provided.

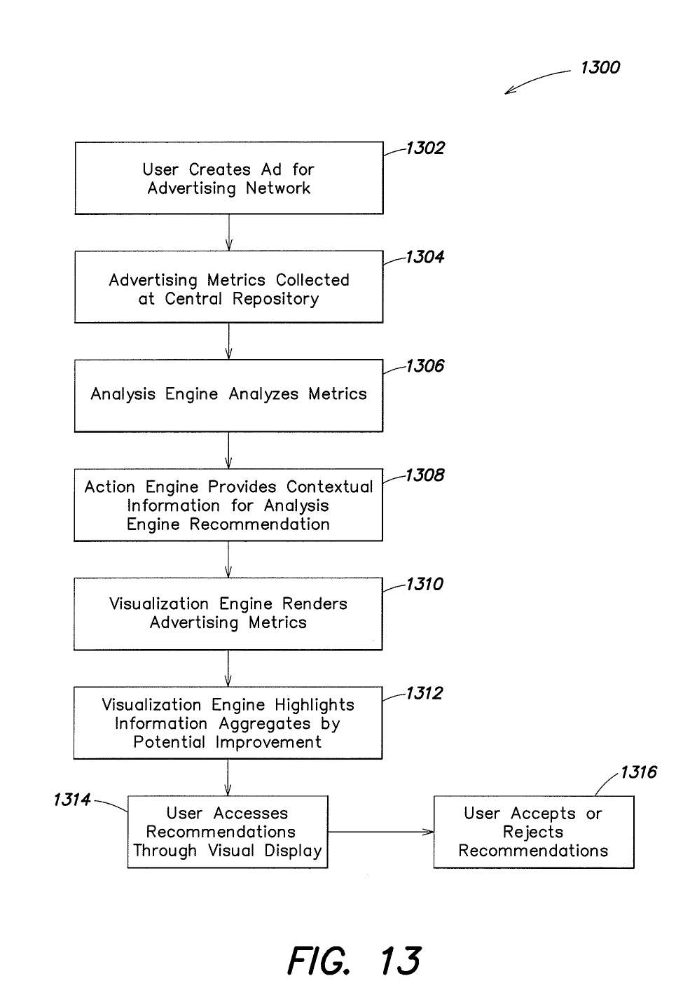

With respect to FIG. 13, an embodiment of a process 1300 for improving ad conversions is shown. At step 1302, an ad is created within an advertising network. One should appreciate that an existing ad may be imported as well as new created as part of process 1300. At 1304 advertising metrics associated with an ad are collected at a central repository. At 1306 the advertising metrics are analyzed to determine recommended actions/alerts to improve ad conversions. At 1308 an action engine provides context for the recommendation, and in one example, the context is provided in term of the analyzed metrics. At 1310 a visualization engine renders advertising metrics as a visual display. At 1312 the visualization engine highlights information aggregates according to the estimated impact on the network. In one example, the visualization engine renders a recommended action in a red background to bring the user's attention to large estimated impact on the network. At 1314 a user accesses a recommendation through the visual display. In one embodiment, a action highlighted in red, indicates a high severity action, by clicking on the red background and/or the displayed action a user accesses the recommended action. At step 1316 the user accepts or rejects the recommendation. Accepting the recommendation improves ad conversions by improving performance of metrics related to the ad.

Various embodiments according to the present invention may be implemented on one or more computer systems. These computer systems may be, for example, general-purpose computers such as those based on Intel PENTIUM-type processor, Motorola PowerPC, AMD Athlon or Turion, Sun UltraSPARC, Hewlett-Packard PA-RISC processors, or any other type of processor. It should be appreciated that one or more of any type computer system may be used to facilitate systems and methods of managing a plurality of advertising networks according to various embodiments of the invention. Further, such computer systems may be used to increase improve online advertising conversions and either system may be located on a single computer or may be distributed among a plurality of computers attached by a communications network.

A general-purpose computer system according to one embodiment of the invention is configured to perform any of the described functions, including but not limited to the functions described for the Analysis Engine, Visualization Engine, and Action Engine, as well as the functions discussed with relation to the Advertising Network Data Feeder and Consolidate Network Repository. Additionally, such functions may include rendering an interface to provide user access, management tools for advertising networks, to receive information and report on advertising networks, to organize and analyze advertising metrics, to generate automated recommendations with respect to the advertising information collected, to generate alerts on the same, and to provide for automatic implementation of the recommendations, as well as reporting on those functions. It should be appreciated, however, that the system may perform other functions, including providing an integrated platform for coordination of the various component of a system for improving online advertising conversions, as well as providing a platform for managing a plurality of advertising networks.

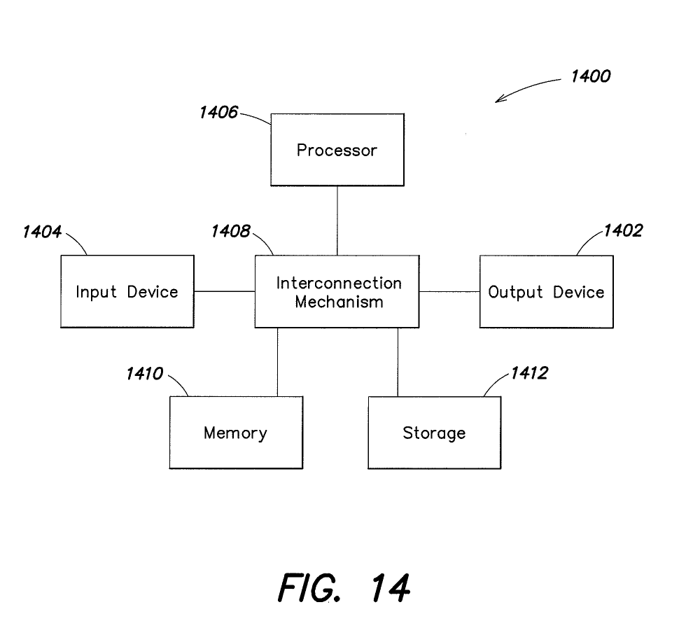

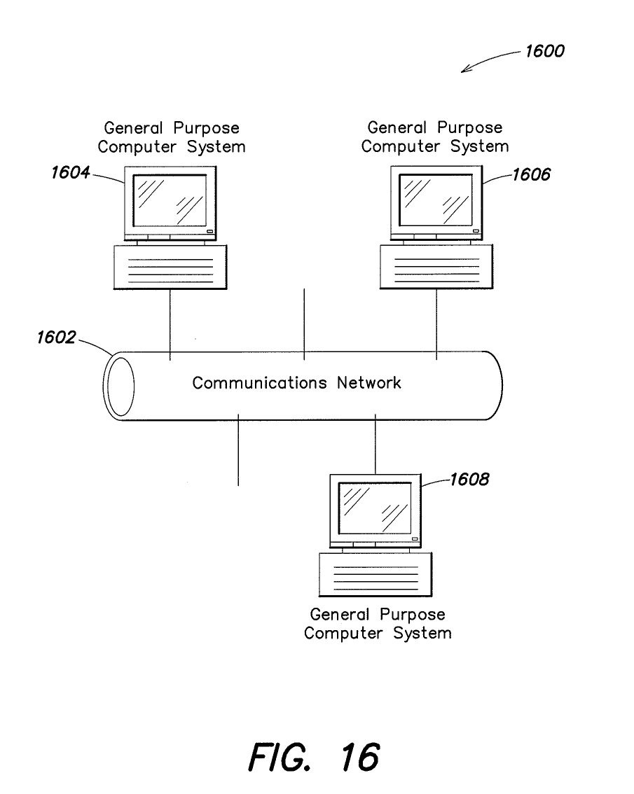

FIG. 14 shows a block diagram of a general purpose computer system 1400 in which various aspects of the present invention may be practiced. For example, various aspects of the invention may be implemented as specialized software executing in one or more computer systems including general-purpose computer systems 1604, 1606, and 1608 communicating over network 1602 shown in FIG. 16. Computer system 1400 may include a processor 1406 connected to one or more memory devices 1410, such as a disk drive, memory, or other device for storing data. Memory 1410 is typically used for storing programs and data during operation of the computer system 1400. Components of computer system 1400 may be coupled by an interconnection mechanism 1408, which may include one or more busses (e.g., between components that are integrated within a same machine) and/or a network (e.g., between components that reside on separate discrete machines). The interconnection mechanism enables communications (e.g., data, instructions) to be exchanged between system components of system 1400.

Computer system 1400 may also include one or more input 1404/output (I/O) devices 1402, for example, a keyboard, mouse, trackball, microphone, touch screen, a printing device, display screen, speaker, etc. Storage 1412, typically includes a computer readable and writeable nonvolatile recording medium in which signals are stored that define a program to be executed by the processor or information stored on or in the medium to be processed by the program.

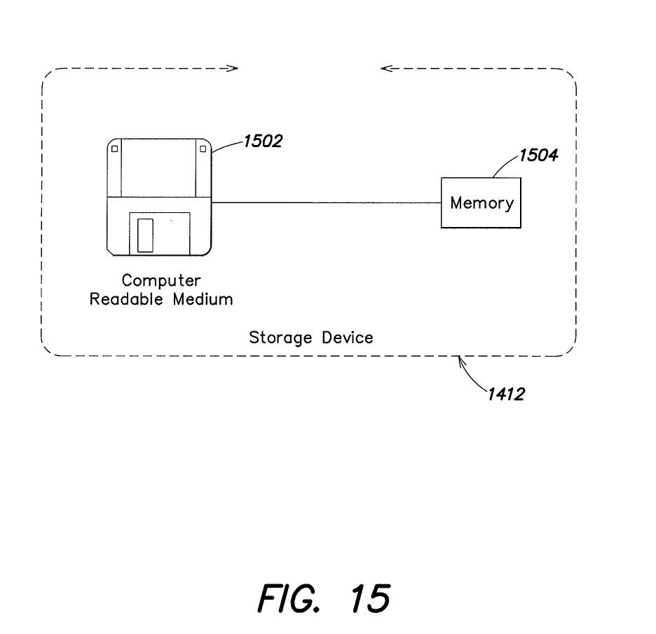

The medium may, for example, be a disk 1502 or flash memory as shown in FIG. 15. Typically, in operation, the processor causes data to be read from the nonvolatile recording medium into another memory 1504 that allows for faster access to the information by the processor than does the medium. This memory is typically a volatile, random access memory such as a dynamic random access memory (DRAM) or static memory (SRAM).

Referring again to FIG. 14, the memory may be located in storage 1412 as shown, or in memory system 1410. The processor 1406 generally manipulates the data within the memory 1410, and then copies the data to the medium associated with storage 1412 after processing is completed. A variety of mechanisms are known for managing data movement between the medium and integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 1400 is shown by way of example as one type of computer system upon which various aspects of the invention may be practiced, it should be appreciated that aspects of the invention are not limited to being implemented on the computer system as shown in FIG. 14. Various aspects of the invention may be practiced on one or more computers having a different architectures or components than that shown in FIG. 14.

Computer system 1400 may be a general-purpose computer system that is programmable using a high-level computer programming language. Computer system 1400 may be also implemented using specially programmed, special purpose hardware. In computer system 1400, processor 1406 is typically a commercially available processor such as the well-known Pentium class processor available from the Intel Corporation. Many other processors are available. Such a processor usually executes an operating system which may be, for example, the Windows-based operating systems (e.g., Windows Vista, Windows NT, Windows 2000 (Windows ME), Windows XP operating systems) available from the Microsoft Corporation, MAC OS System X operating system available from Apple Computer, one or more of the Linux-based operating system distributions (e.g., the Enterprise Linux operating system available from Red Hat Inc.), the Solaris operating system available from Sun Microsystems, or UNIX operating systems available from various sources. Many other operating systems may be used, and the invention is not limited to any particular operating system.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems (e.g., servers) configured to provide a service to one or more client computers, or to perform an overall task as part of a distributed system. For example, various aspects of the invention may be performed on a client-server or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the invention may be programmed using an object-oriented programming language, such as Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Various aspects of this invention can be implemented by one or more systems similar to system 1400. For instance, the system may be a distributed system (e.g., client server, multi-tier system) comprising multiple general-purpose computer systems. In one example, the system includes software processes executing on a system associated with a user/manager (e.g., a client computer system). These systems may permit authorization of a user locally or may permit remote authorization of a user using login name and password. There may be other computer systems that perform functions such as receiving and analyzing advertising metrics, generating recommended actions and alerts, rendering an interface for managing a plurality of advertising networks, rendering an interface for a system for improving online advertising conversions, implementing the functions discussed above with respect to an analysis engine, visualization engine, action engine, consolidated network repository, and advertising network data feeder, as well as other computer systems that may host the advertising networks that generated the raw data to be analyzed, etc. Additional functions may also include providing for generation of reports from advertising metrics, providing recommended actions and alerts, estimating the impact of an action or alert on aspects of an advertising network and/or on advertising metrics, assigning a level of importance to acts and alerts based on estimated impact, suggesting design changes to improve advertisements, searching for similar advertisements based on advertising metrics, and suggesting design changes based on search results, establishing secure information for accessing the system, visually aggregating advertising information, providing visual cues to highlight information based on estimated impact and/or importance to the advertising network, providing for the automatic implementation of recommendations, etc. These systems may be distributed among a communication system such as the Internet. One such distributed network, as discussed below with respect to FIG. 16, may be used to implement various aspects of the invention.

FIG. 16 shows an architecture diagram of an example distributed system 1600 suitable for implementing various aspects of the invention. It should be appreciated that FIG. 16 is used for illustration purposes only, and that other architectures may be used to facilitate one or more aspects of the invention.

System 1600 may include one or more general-purpose computer systems distributed among a network 1602 such as, for example, the Internet. Such systems may cooperate to perform functions related to user authentication. In an example of one such system for user authentication, one or more users is authenticated over one or more client computer systems 1604, 1606, and 1608 through which a user manages a plurality of advertising networks, and alternatively or in conjunction, improves online advertising conversions. It should be understood that the one or more client computer systems 1604, 1606, and 1608 may also be used to access, for example, a secure or unsecured site that includes management and improvement functions for advertising campaigns, ads, advertising networks, etc., based on various aspects of the invention. In one example, user access such system(s) via an Internet-based interface.

In one example, a system 1604 includes a browser program such as the Microsoft Internet Explorer application program through which one or more websites may be accessed. Further, there may be one or more application programs that are executed on system 1604 that perform functions associated with user authentication. System 1604 may include one or more local databases including, but not limited to, advertising metrics, aggregated advertising metrics from a plurality of advertising networks, reports generated on the raw data or aggregated information, information relating to user authentication, information relating to advertising networks, campaigns, ad groups, keywords, ads, etc., information relating to generation of recommended actions and alerts, information relating to estimated impact of recommended actions and alerts on the advertising account, as well as information related to resolution of recommended actions and alerts, whether done by a user or automatically.

Network 1602 may also include, as part of the system for managing a plurality of advertising networks and the system for improving advertising conversions, authenticating user(s) on one or more server systems, which may be implemented on general purpose computers that cooperate to perform various functions of the systems for managing a plurality of advertising networks and/or the system for improving advertising conversions. Such function may include authorization of a user locally or may permit remote authorization of a user using login name and passwords, receiving and analyzing advertising metrics, generating recommended actions and alerts, rendering an interface for managing a plurality of advertising networks, rendering an interface for a system for improving online advertising conversions, implementing the functions discussed above with respect to an analysis engine, visualization engine, action engine, consolidated network repository, and advertising network data feeder, as well as other function for hosting the advertising networks that generate the raw data to be analyzed, etc. Additional functions may also include providing for generation of reports from advertising metrics, providing recommended actions and alerts, estimating the impact of an action or alert on aspects of an advertising network and/or on advertising metrics, assigning a level of importance to acts and alerts based on estimated impact, suggesting design changes to improve advertisements, searching for similar advertisements based on advertising metrics, and suggesting design changes based on search results, establishing secure information for accessing the system, visually aggregating advertising information, providing visual cues to highlight information based on estimated impact and/or importance to the advertising network, etc. System 1600 may optionally provide support for the management system and the system to improve advertising conversions, as well as feedback mechanism for suggesting improvements to the management system. System 1600 may execute any number of software programs or processes and the invention is not limited to any particular type or number of processes. Such processes may perform the various workflows associated with the system for authenticating user(s).

One should appreciate that FIGS. 1-10 illustrate embodiments according to aspects of the present invention, however, modification of specific elements of the particular embodiments are contemplated as part of the present invention. For example, links should be interpreted generally in the context of systems implemented on web pages to include references within a particular web page, as well as references to other web pages and are meant to encompass links presented as images, as text, as well as to cover references where no new page is loaded but new data is incorporated into a present view. Radio buttons, drop down menus/lists, check boxes are all known elements of standard web pages and modifying them so that the option to select displays differently is also intended to be covered.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for managing a plurality of advertising networks, the method comprising acts of:
aggregating advertising metrics related to at least one of the plurality of advertising networks;
analyzing the at least one of the plurality of advertising networks using advertising metrics;
displaying the at least one of the plurality of advertising networks visually;
displaying an indication related to the visual display of the at least one of the plurality of advertising networks that indicates an action exists for the at least one of the plurality of advertising networks; and
indicating, visually, a ranking for a recommendation.

2. The method according to claim 1, further comprising an act of indicating on the visual display of the at least one of the plurality of advertising networks the ranking for the recommendation using a visual cue.

3. The method according to claim 2, wherein the visual cue comprises at least one of color, font, background, texture, size, and shape.

4. The method according to claim 1, wherein aggregating advertising metrics related to the at least one of the plurality of advertising networks further comprises aggregating advertising metrics related to at least one of advertisement driver, advertisement quality, conversion process, cost, and sales.

5. The method according to claim 1, wherein the advertising metrics are associated with an advertising node.

6. The method according to claim 5, further comprising acts of:
visually displaying the advertising node; and
displaying advertising metrics in response to an event.

7. The method according to claim 6, wherein displaying advertising metrics occurs in response to at least one of a browser related event, a temporal event, an update event, and a status event.

8. The method according to claim 1, wherein the act of analyzing at least one of the plurality of advertising networks further comprises an act of weighting advertising metrics.

9. The method according to claim 8, further comprising an act of generating a recommendation value based on the weighted advertising metrics.

10. The method according to claim 1, further comprising an act of generating a recommendation value based on an estimated impact on the at least one of the plurality of advertising networks.

11. The method according to claim 9, further comprising an act of visually indicating at least one recommendation value by graphically rendering an advertising node.

12. The method according to claim 1, wherein the act of analyzing at least one of the plurality of advertising networks further comprises an act of determining a return on investment value.

13. The method according to claim 12, further comprising an act of visually indicating the return on investment value by graphically rendering an advertising node.

14. A system for managing a plurality of advertising networks, the system comprising:
an aggregation engine for aggregating information related to at least one of a plurality of advertising networks;
a visualization engine for rendering information related to a managed advertisement; and
an analysis engine for analyzing advertising metrics, wherein the analysis engine is further adapted to determine recommendations for the at least one of a plurality of advertising networks.

15. The system of claim 14, further comprising a dashboard for visually displaying the at least one of a plurality of advertising networks and information related to the managed advertisement.

16. The system of claim 15, further comprising an action engine for providing context to the determined recommendations.

17. The system of claim 14, wherein the recommendations comprise at least one of an action and an alert related to the at least one of a plurality of advertising networks.

18. The system of claim 14, wherein the analysis engine is further adapted to estimate an impact on at least one of the plurality of advertising networks based at least in part on the recommendation.

19. The system of claim 18, wherein the visualization engine renders the estimated impact on the advertising network.

20. The system of claim 19, wherein the visualization engine renders the estimated impact as part of the dashboard.

21. The system of claim 14, wherein the visualization engine renders information associated with the managed advertisement as visual aggregates of information.

22. The system of claim 21, wherein the visual aggregates of information comprise a hierarchical organization.

23. The system of claim 21, wherein the visual aggregates of information comprise advertising nodes.

24. The system of claim 14, wherein the visualization engine emphasizes information related to the managed ad using visual cues.

25. The system of claim 23, wherein the visual cues comprise at least one of color, background, texture, size, shape, and font.

26. A system for improving online advertising conversions, said system comprising:
an analysis engine that analyzes the raw advertising metrics to identify one or more improvements;
a visualization engine that allows the user to visualize a tree in two-dimensional space; and
an action engine that allows a user to take an action to improve its advertising campaign.

27. The system according to claim 26, wherein the analysis engine is further adapted to organize advertising elements into a hierarchical arrangement.

28. The system according to claim 27, wherein the analysis engine is further adapted to associate the raw advertising metrics with the organized advertising elements.

29. The system of claim 26, wherein the visualization engine is further adapted to display visual information aggregates.

30. The system of claim 29, wherein the visual information aggregates comprise hierarchical advertising elements.

31. The system of claim 26, wherein the analysis engine is further adapted to provide a recommendation.

32. The system of claim 31, wherein the recommendation comprises, at least in part, one of an action and an alert.

33. The system of claim 31, wherein the action engine is further adapted to generate context for the recommendation.

34. The system of claim 33, wherein the context for the recommendation comprises an estimated impact associated with the recommendation.

35. The system of claim 33, wherein the context for the recommendation comprises analysis performed on the raw advertising metrics associated with the recommendation.

36. The system of claim 33, wherein the action engine is further adapted to highlight significant portions of the context.

37. The system of claim 31, wherein the visualization engine is further adapted to display visual cues related to the recommendation.

38. The system of claim 37, wherein the visual cues comprise at least one of color, font, background, texture, size, and shape.

39. A computer implemented method for improving online advertising conversions, said method comprising:
analyzing the raw advertising metrics to identify improvements to conversion in online advertising;
visualizing a tree in two-dimensional space in a treemap based visualization; and
providing a rapid one-box recommendation that allows a user to take an action to improve its advertising campaign.

40. The method of claim 39, further comprising an act of providing context associated with the action to improve the advertising campaign.

41. The method of claim 39, wherein analyzing the raw advertising metrics further comprises determining if the raw advertising metrics meet a predefined threshold.

42. The method of claim 39, further comprising an act of estimating an impact on the advertising campaign, based on the recommendation.

43. The method of claim 42, wherein the estimated impact is based at least in part on, at least one of, a return on investment, click thru rate, conversions, conversion rate, impressions, unique visits, quality score of a landing page, a value of goods, visits to a desired product page, and average advertising position.

44. A computer implemented advertising system for managing a plurality of advertising networks, the system comprising:
a presentation engine for rendering a visual interface for a user to access functions associated with at least one of the plurality of advertising networks;
an execution engine for providing and executing functions associated with the at least one of the plurality of advertising networks; and
a data engine for analyzing metrics associated with the at least one of the plurality of advertising networks.

45. The system according to claim 44, wherein the data engine is further adapted to receive data from a plurality of advertising networks.

46. The system according to claim 44, wherein the data engine is further adapted to determine whether the analyzed metrics meet a predetermined threshold.

47. The system according to claim 44, wherein the predetermined threshold is associated with a recorded change over time in the analyzed metrics.

48. The system according to claim 47, wherein the analyzed metrics comprise at least one of a return on investment, click thru rate, conversions, conversion rate, impressions, unique visits, quality score of a landing page, a value of goods, visits to a desired product page, and average advertising position.

49. The system according to claim 47, wherein the execution engine is further adapted to provide a recommendation.

50. The system according to claim 49, wherein the presentation engine is further adapted to display the recommendation, associated context, and an option for accepting the recommendation.

51. The system according to claim 50, wherein the associated context comprises the analyzed metrics associated with the at least one of the plurality of advertising networks.

52. The system according to claim 50, wherein the data engine is further adapted to generate an estimated impact on the at least one of the plurality of advertising networks for the recommendation.
